(19) United States
(12) Patent Application Publication
(10) Pub. No.: US 2026/0255202 A1
(43) Pub. Date: Aug. 27, 2026

(54) UE COOPERATION FOR SIGNAL MEASUREMENTS AND PREDICTIONS

(71) Applicant: QUALCOMM Incorporated, San Diego, CA (US)

(72) Inventors: Doohyun SUNG, Basking Ridge, NJ (US); Navid ABEDINI, Basking Ridge, NJ (US); Junyi LI, Greentown, PA (US)

(21) Appl. No.: 19/065,987

(22) Filed: Feb. 27, 2025

(51) Int. Cl. H04W 24/10

(52) U.S. Cl. CPC H04W 24/10

(57) ABSTRACT

Certain aspects of the present disclosure provide techniques for cooperative-based operation for cooperatively performing signal measurements and/or cooperatively generating prediction data. In some cases, a method performed by a first user equipment (UE) may include determining a group of UEs for cooperative-based operation in which at least one of signal measurements are cooperatively performed among the group of UEs or prediction data is cooperatively generated among the group of UEs, obtaining, according to the cooperative-based operation, signal measurements for one or more signals, generating, according to the cooperative-based operation, prediction data by inputting the signal measurements into one or more prediction models, and transmitting a report indicating at least one of the signal measurements or the prediction data

### BACKGROUND

### Field of the Disclosure

Aspects of the present disclosure relate to wireless communications, and more particularly, to techniques for user equipment (UE) cooperation for signal measurements and predictions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE). The method includes determining a group of UEs for cooperative-based operation in which at least one of signal measurements are cooperatively performed among the group of UEs or prediction data is cooperatively generated among the group of UEs; obtaining, according to the cooperative-based operation, signal measurements for one or more signals; generating, according to the cooperative-based operation, prediction data by inputting the signal measurements into one or more prediction models; and transmitting a report indicating at least one of the signal measurements or the prediction data.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a diagram depicting an example of artificial intelligence (AI)/machine learning (ML) functional framework for radio access network (RAN) intelligence.

FIG. 6A illustrates an example wireless communications network without user equipment (UE) cooperation.

FIG. 6B illustrates an example wireless communications network with UE cooperation.

FIG. 7 illustrates a wireless communication network in which a cooperative measurement and prediction framework may be used for cooperatively performing signal measurements and/or cooperatively generating prediction data based on one or more prediction models.

FIG. 8 illustrates a first manner in which prediction data may be generated by a group of UEs.

FIG. 9 illustrates a second manner in which prediction data may be generated by a group of UEs.

FIG. 10 illustrates a third manner in which prediction data may be generated by a group of UEs.

FIG. 11 depicts a process flow including operations for communications in a network between a network entity, a first UE, and one or more second UEs.

FIG. 12 depicts a method for wireless communications.

FIG. 13 depicts aspects of an example communications device.

### DETAILED DESCRIPTION

Aspects of the present disclosure provide apparatuses, methods, processing systems, and computer-readable mediums for cooperative-based operation in a wireless communication network for cooperatively performing signal measurements and/or cooperatively generating prediction data.

For example, wireless communication networks rely on periodic radio resource management (RRM)-based signal measurements to assess network conditions and facilitate mobility and resource allocation decisions. Each user equipment (UE) independently receives a measurement configuration from the network, performs signal measurements and reports results based on predefined conditions. While this approach ensures that each UE provides tailored feedback, it may also lead to inefficiencies, particularly in dense UE deployments where redundant measurements generate excessive signaling overhead and increase processing and power consumption for both the UEs and the network.

To enhance network efficiency, artificial intelligence (AI) and/or machine learning (ML) frameworks are increasingly being integrated into wireless systems to optimize resource allocation and improve performance. By analyzing historical network conditions, mobility patterns, and real-time measurements, AI/ML prediction models support proactive decision-making for handovers, beamforming, and interference mitigation. However, as these models grow in complexity, they require larger training datasets and higher computational resources, posing challenges for resource-constrained UEs. Running AI/ML inference tasks on UEs can increase power consumption, impact battery life, and strain device processing capabilities, highlighting the need for more efficient approaches to AI/ML integration in wireless networks.

Accordingly, aspects of the present disclosure provide a cooperative measurement and prediction framework for addressing the inefficiencies and power consumption associated with per-UE measurement configuration and reporting, as well as the challenges associated with the increasing computational demands of AI/ML-based prediction models. More specifically, aspects of the present disclosure provide cooperative-based operation techniques for enabling UE cooperation associated with the performance of signal measurements and the generation of prediction data (e.g., predicted future signal measurements) based on the performed signal measurements. In some cases, these techniques may help to reduce power consumption associated with per-UE measurement and reporting, as well as reducing the computational burden and power consumption associated with AI/ML predictions, by using distributed processing and/or offloading inference tasks to other nodes in the network with greater processing capabilities.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

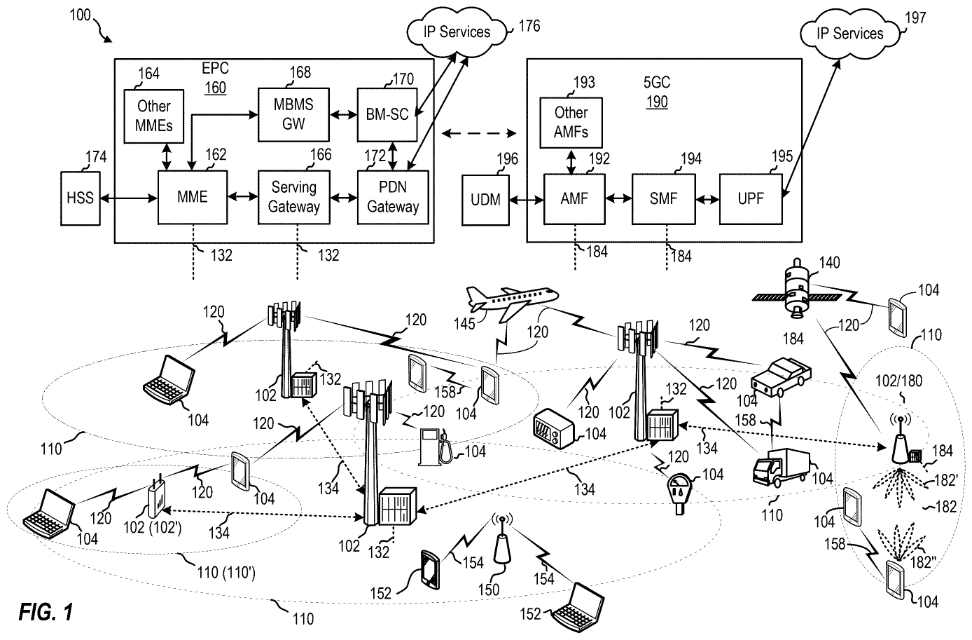

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

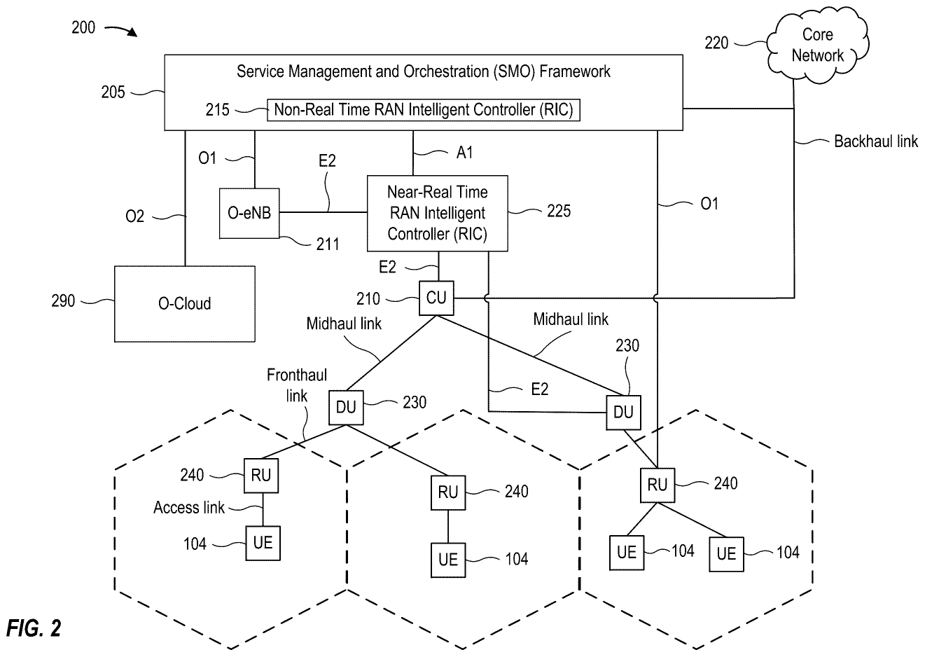

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

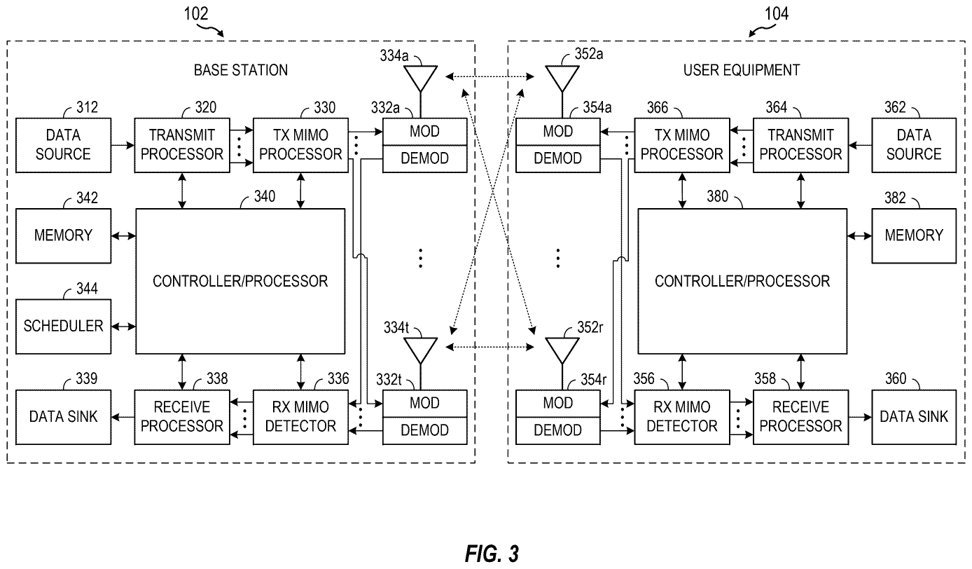

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

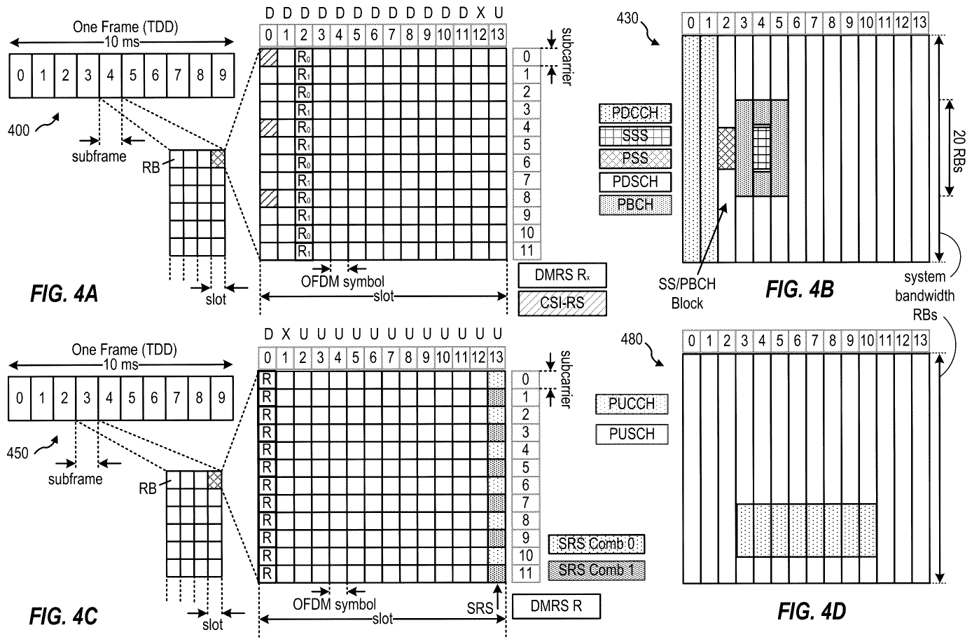

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of AI/ML Functional Framework for RAN Intelligence

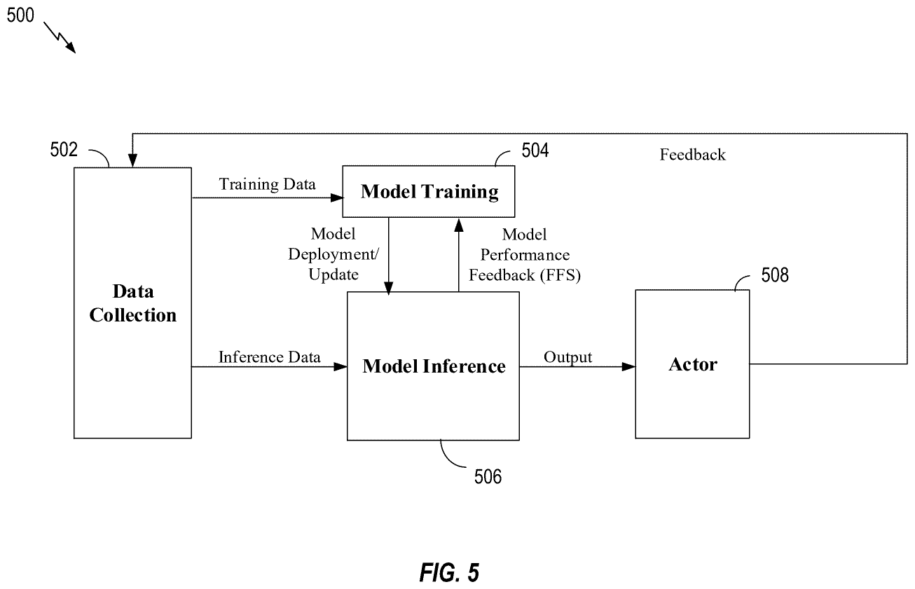

FIG. 5 illustrates a diagram 500 depicting an example of artificial intelligence (AI)/machine learning (ML) functional framework for radio access network (RAN) intelligence. In some cases, the AI/ML functional framework may be used by one or more nodes within the RAN, such as a UE, to make predictions or inferences about the input data and optimize various network operations. The AI/ML functional framework includes a data collection function 502, a model (or prediction algorithm) training function 504, a model (or prediction algorithm) inference function 506, and an actor function 508, which interoperate to provide a platform for collaboratively applying AI/ML to various procedures in the RAN.

The data collection function 502 provides input data to the model training function 504 and the model inference function 506. AI/ML algorithm specific data preparation (e.g., data pre-processing and cleaning, formatting, and transformation) may not be carried out in the data collection function 502.

Examples of input data to the data collection function 502 (or other functions) may include measurements from UEs or different network entities, feedback from the actor function, and output from an AI/ML model (e.g., such as a prediction algorithm). In some cases, analysis of data needed at the model training function 504 and the model inference function 506 may be performed at the data collection function 502. As illustrated, the data collection function 502 may deliver training data to the model training function 504 and inference data to the model inference function 506.

The model training function 504 may perform AI/ML model training, validation, and testing, which may generate model performance metrics as part of the model testing procedure. The model training function 504 may also be responsible for data preparation (e.g., data pre-processing and cleaning, formatting, and transformation) based on the training data delivered by the data collection function 502, if required.

The model training function 504 may provide model deployment/update data to the model inference function 506. The model deployment/update data may be used to initially deploy a trained, validated, and tested AI/ML model to the model inference function 506 or to deliver an updated model to the model inference function 506.

As illustrated, the model inference function 506 may provide AI/ML model inference output (e.g., predictions or decisions) to the actor function 508 and may also provide model performance feedback to the model training function 504, at times. The model inference function 506 may be responsible for data preparation (e.g., data pre-processing and cleaning, formatting, and transformation) based on inference data delivered by the data collection function 502, at times.

The inference output of the AI/ML model may be produced by the model inference function 506. Specific details of this output may be specific in terms of use cases. The model performance feedback may be used for monitoring the performance of the AI/ML model, at times. In some cases, the model performance feedback may be delivered to the model training function 504, for example, if certain information derived from the model inference function is suitable for improvement of the AI/ML model trained in the model training function 504.

The model inference function 506 may signal the outputs of the model to nodes that have requested them (e.g., via subscription), or nodes that take actions based on the output from the model inference function. An AI/ML model used in a model inference function 506 may need to be initially trained, validated and tested by a model training function before deployment. The model training function 504 and model inference function 506 may be able to request specific information to be used to train or execute the AI/ML algorithm and to avoid reception of unnecessary information. The nature of such information may depend on the use case and on the AI/ML algorithm.

The actor function 508 may receive the output from the model inference function 506, which may trigger or perform corresponding actions. The actor function 508 may trigger actions directed to other entities or to itself. The feedback generated by the actor function 508 may provide information used to derive training data, inference data or to monitor the performance of the AI/ML model. As noted above, input data for a data collection function 502 may include this feedback from the actor function 508. The feedback from the actor function 508 or other network entities (e.g., via data collection function) may also be used at the model inference function 506.

The AI/ML functional framework may be deployed in various RAN intelligence-based use cases. Such use cases may include channel state information (CSI) feedback enhancement, enhanced beam management (BM), positioning and location accuracy enhancement, and various other use cases.

### Introduction to AI/ML for Beam Prediction

5G-Advanced wireless networks herald the prospect of a thoroughly interconnected and mobile society characterized by the expectation of a high throughput, energy efficient, immersive and data-driven radio access networks (RANs). Coupled with data-driven approaches, a RAN has the potential to develop predictive capabilities that learn from an environment through the use of AI/ML techniques. Therefore, companies are presently integrating AI/ML technologies into the existing 5G network and devices.

Beam management (BM) represents one use case for applying AI/ML models. A legacy BM process is time-inefficient and not scalable when a size of antenna arrays of a device increases. ML algorithms may replace sequential beam sweeping by predicting beams in both time and spatial domains.

For beam prediction, a user equipment (UE) may measure a first set of transmit (TX) beams defined as set B beams and may predict a second set of Tx beams defined as set A beams. The set B beams may have different characteristics such as beam shape, width and/or set of angular directions in comparison to the beams in a set A. For instance, the set B beams may be wide synchronization signal block (SSB) beams used for transmitting synchronization signals and providing coverage, whereas the set A beams may be refined channel state information-reference signal (CSI-RS) beams used for improving signal-to-interference-plus-noise ratio (SINR) at the UE. A wide SSB beam in a set B may be generated by a linear combination of adjacent CSI-RS beams in the set A where one SSB beam may encompass multiple (e.g., three) adjacent CSI-RS beams in azimuth direction and two CSI-RS beams in elevation direction. Thus, given an input constituted by measurements of the SSB beams, an AI/ML model may provide as output top K number of predicted CSI-RS beam indices.

The AI/ML model for the beam prediction may be trained and deployed at the UE and at a gNodeB (gNB).

Data collection for AI/ML model training may use beam measurement and reporting frameworks. For instance, the gNB configures the UE with a CSI reporting configuration to perform measurements of the set A and set B beams. The measurements collected across various UEs and time occasions may be uploaded to a server for offline AI/ML model training. The UE may measure reference signal (RS) resources corresponding to different TX beams using an optimal receive (RX) beam determined by previous measurements. The UE may filter instantaneous reference signal receive power (RSRP) measurements to mitigate the effects of fast fading with a layer-1 (L1) filter and collect L1-RSRP measurements.

For a UE-sided AI/ML model, data may be collected by measuring RSs corresponding to the set A and set B beams at the UE, where the set A measurements may be used to derive a best beam index to be used as a label and L1-RSRP measurements associated with the set B beams to be used as input data. For a gNB-sided AI/ML model, the UE is configured to measure the set A and set B beams and report to the gNB a best beam index in the set A beams to be used as the label in addition to the L1-RSRP measurements of the set B beams for the input data.

Once the trained AI/ML model may be deployed at the UE or the gNB, the gNB configures the UE to measure the set B beams to be used as input to the AI/ML model during inference. For the UE-sided AI/ML model, the UE predicts a top K number of beams in the set A based on L1-RSRP measurements associated with the set B beams and then reports the predicted top K number of beams to the gNB. For the NW-sided AI/ML model, the UE may be configured to report all set B beam measurements to be used as input of the AI/ML model for inference.

After the UE performs inference and reports the predicted top K number of beams to the gNB or after the gNB obtains the predicted top K number of beams based on the inference, the gNB may perform an additional step of refined measurements of the top K number of predicted beams. Alternatively, the predicted top K number of predicted beams may be used directly without a step of refined measurements to make informed decisions (e.g., about transmission control information (TCI) state activation and indication to the UE). A downlink control message (DCI) including a TCI state may be transmitted to the UE to indicate a downlink TX beam to use for receiving downlink channels.

### Introduction to UE Cooperation

The idea of employing cooperation in wireless communication networks has emerged in response to user mobility support and limited energy and radio spectrum resources, which pose challenges in the development of wireless communication networks and services in terms of capacity and performance.

Cooperative wireless communication may involve a wireless network where wireless agents, e.g., user equipments (UEs), increase their effective quality of service (measured at the physical (PHY) layer by bit error rates, block error rates, or outage probability) via cooperation. In a cooperative communication system, each UE is assumed to transmit data as well as act as a cooperative agent for another UE.

Mobile wireless channels suffer from fading, meaning that signal attenuation can vary significantly over the course of a given transmission. By transmitting independent copies of a signal, cooperating UEs may combat the deleterious effects of fading through signal diversity. In particular, spatial diversity may be generated by transmitting signals from different locations, thus allowing independently faded versions of the signal at the receiver. However, many wireless devices (including UEs) may be limited by size and/or cost to reduced processing resources (e.g., limited to one antenna). Accordingly, cooperative communication has been proposed to enable devices, such as single antenna UEs, in a multi-user environment to share their antennas and generate a virtual multiple-antenna transmitter (e.g., a virtual UE) that allows the UEs to achieve spatial diversity. This may represent increased resource utilization. In other words, idle UEs cooperate with active UEs to create a single virtual UE in order to utilize full network throughput.

For example, for cooperative communication, two UEs may be communicating with a same network entity (e.g., a base station). Each UE has one antenna and cannot individually generate spatial diversity. However, it may be possible for one UE to receive information from the other UE, in which case the receiving UE can forward some version of the information from the other UE along with its own data to the network entity. Because the fading paths from two UEs are statistically independent, this generates spatial diversity. Further, a cooperative link established between the two UEs may use unlicensed spectrum to ensure all licensed spectrum remains available to the network.

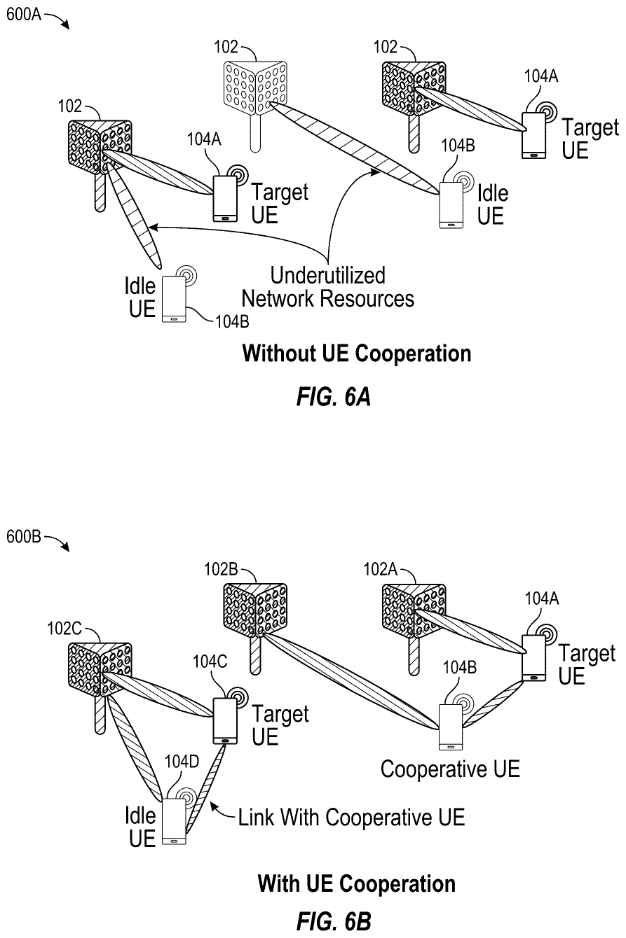

FIG. 6A illustrates an example wireless communications network 600A without UE cooperation, in accordance with certain aspects of the present disclosure. As shown in FIG. 6A, a target UE (e.g., such as UE 104a illustrated in wireless communication network 100 of FIG. 1) and an idle UE (e.g., such as UE 104b illustrated in wireless communication network 100 of FIG. 1) may each communicate with a network entity (e.g., such as BS 102 illustrated in wireless communication network 100 of FIG. 1). As shown, however, because target UE 104a and idle UE 104b do not establish a cooperative link between each other, in this example, network resources may be under-utilized, and thus, throughput may be limited.

In contrast, FIG. 6B illustrates an example wireless communications network 600B with UE cooperation, in accordance with certain aspects of the present disclosure. In the example shown in FIG. 6B, target UE 104a and cooperative UE 104b may establish a cooperation connection to utilize full network throughput. Further, as described above, the link between target UE 104a and cooperative UE 104b may allow for use of unlicensed spectrum.

In certain aspects, cooperative UE updates (as well as UE capability updates) may be transparent to a network entity (e.g., gNB), such as in physical layer (PHY, Layer 1, or L1) or medium access control (MAC) layer (Layer 2 or L2) based solutions. For example, a cooperative UE (e.g., a UE which had previously established a cooperation connection with a target UE) may be removed and/or a cooperation candidate UE may establish a cooperation connection with a target UE (e.g., causing the cooperation candidate UE to be a cooperative UE with the target UE) without the network entity's awareness.

In this case, a multiple-transmission reception point (multi-TRP) framework may be used. In other words, cooperating UEs may access wireless networks via multiple TRPs to help support increased mobile data traffic and enhance the coverage. Multi-TRPs may be used to implement one or more macro-cells, small cells, pico-cells, or femto-cells, and may include remote radio heads, relay nodes, and the like.

In certain other aspects, UE capability updates may be reported to the network entity in higher layer (e.g., Layer 3 or L3 or higher layer) based solutions. For example, in such cases, a cooperative UE may not be removed and/or a cooperation candidate UE may not establish a cooperation connection with a target UE without the network entity's awareness. In this case, a UE capability update reported to the network entity may be UE-controlled. For example, a target UE may select a cooperative candidate UE to establish a cooperation connection with. The target UE may establish a cooperation connection with the selected cooperative candidate UE to create a single virtual UE. The target UE may then transmit a capability update to the network entity, to reflect the additional capability of the virtual UE (relative to the target UE alone).

### Aspects Related to UE Cooperation for Signal Measurements and Predictions

UEs in a wireless communication network may be configured to periodically perform radio resource management (RRM)-based signal measurements to evaluate network conditions and assist in mobility and resource allocation decisions. These measurements, which include Reference Signal Received Power (RSRP), Reference Signal Received Quality (RSRQ), Signal-to-Interference-plus-Noise Ratio (SINR), and Channel Quality Indicator (CQI), are configured, performed, and reported on a per-UE basis. That is, each UE independently receives its measurement configuration from the network, performs the required signal measurements, and generates individual measurement reports based on predefined triggering conditions, such as periodic reporting intervals or event-based thresholds.

While this per-UE measurement configuration and reporting approach may ensure that each UE provides the network with feedback that is tailored to that UE's specific radio conditions, it can also lead to inefficiencies. Specifically, redundant or overlapping measurements from multiple UEs in the same vicinity may result in excessive signaling overhead and unnecessary consumption of network resources. Additionally, this approach can increase processing and power consumption for both the UEs and the network, particularly in scenarios with dense UE deployments where many UEs generate frequent and similar measurement reports.

As discussed above, an AI/ML framework is increasingly being integrated into wireless communication networks to enhance network management, optimize resource allocation, and improve overall performance. AI/ML prediction models enable predictive analytics by processing various input data, such as historical network conditions, mobility patterns, and real-time radio measurements, to make informed decisions on handovers, beamforming, interference mitigation, and other network optimizations. These prediction models allow networks to operate more efficiently by anticipating future conditions and proactively adjusting network parameters.

However, as AI/ML features become more prevalent in wireless communication systems, the complexity and size of these prediction models, as well as the amount of required input data, are rapidly increasing. Larger models often require more extensive training datasets and higher computational resources, which can significantly impact memory/storage requirements and processing capabilities, particularly for resource-constrained devices such as UEs. Additionally, executing complex AI/ML inference tasks on UEs can lead to higher power consumption, reducing battery life and potentially degrading the device's performance.

Accordingly, aspects of the present disclosure provide a cooperative measurement and prediction framework for addressing the inefficiencies and power consumption associated with per-UE measurement configuration and reporting, as well as the challenges associated with the increasing computational demands of AI/ML-based prediction models. More specifically, aspects of the present disclosure provide cooperative-based operation techniques for enabling UE cooperation associated with the performance of signal measurements and the generation of prediction data (e.g., predicted future signal measurements) based on the performed signal measurements. In some cases, these techniques may help to reduce power consumption associated with per-UE measurement and reporting, as well as reducing the computational burden and power consumption associated with AI/ML predictions, by using distributed processing and/or offloading inference tasks to other nodes in the network with greater processing capabilities.

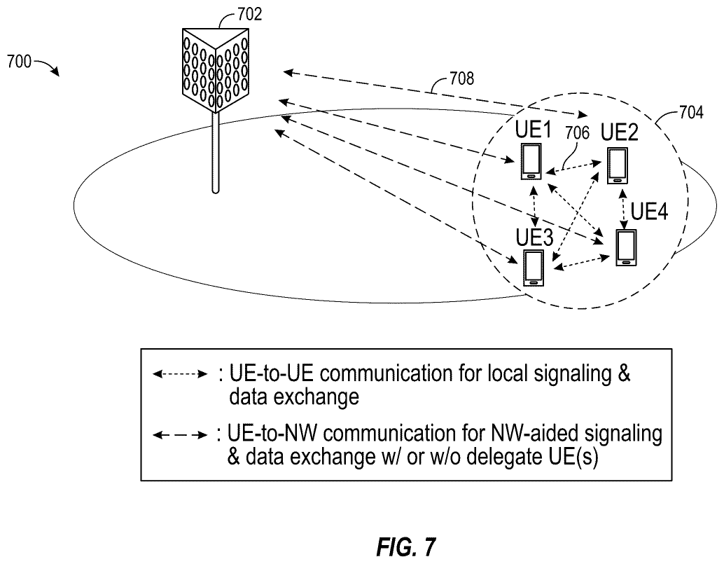

FIG. 7 illustrates a wireless communication network 700 in which a cooperative measurement and prediction framework may be used for cooperatively performing signal measurements and/or cooperatively generating prediction data based on one or more AI/ML prediction models. As shown, the wireless communication network 700 includes a network entity 702 and a plurality of UEs (e.g., UE1, UE2, UE3, and UE4). In some cases, the network entity 702 may be an example of the BS 102 while each of the UEs of the plurality of UEs may be an example of the UE 104 described above.

In some cases, when cooperative-based operation is configured, the plurality of UEs may form a group of UEs 704 for at least one of cooperatively performing signal measurements among the group of UEs 704 or cooperatively generating prediction data among the group of UEs 704. For example, in some cases, the cooperative-based operation may involve one or more cooperative modes. In some cases, the one or more cooperative modes may include a first cooperative mode, such as a measurement delegation mode, in which a UE operates as a delegate UE to perform signal measurements on behalf of one or more UEs of the group of UEs 704. In some cases, the signal measurements may include RRM-based measurements (e.g., RSRP, RSRQ, SINR, CQI, etc.) performed on one or more reference signals (RSs) transmitted by the network entity 702, such as one or more synchronization signal blocks (SSBs) and/or channel state information reference signal (CSI-RSs).

As an example, in some cases, UE1 of the group of UEs 704 may be delegated to perform signal measurements for one or more other UEs of the group of UEs 704, such as UE2, UE3, and/or UE4. In some cases, after performing the signal measurements for the one or more other UEs of the group of UEs 704, UE1 may use UE-to-UE communication 706 (e.g., sidelink, Bluetooth, etc.) to transmit a report to the one or more other UEs including the signal measurements.

In some cases, the one or more cooperative modes may include a second cooperative mode, such as a measurement collaboration mode, in which each UE of the group of UEs performs a different subset of signal measurements and the different subsets of signal measurements may be aggregated together by one UE of the group of UEs. For example, in some cases, each of the UEs of the group of UEs 704 (e.g., UE1, UE2, UE3, and UE4) may perform a different subset of temporal-based signal measurements (e.g., measurements performed at different times) or a different subset of spatial-based signal measurements (e.g., signal measurements performed for different spatial directions). In some cases, each of the UEs may be configured to share their respective subset of signal measurements with each other or with a delegate UE to aggregate and derive a full set of signal measurements.

In some cases, the one or more cooperative modes may include a third cooperative mode, such as a first prediction mode, in which a UE is configured to generate prediction data using a prediction model based on signal measurements resulting from the measurement delegation mode or the measurement collaboration mode. For example, in some cases, each UE of the group of UEs 704 may be configured to individually generate prediction data for itself using a prediction model based on signal measurements that that UE itself performed and/or signal measurements that another UE in the group of UEs 704 performed for that UE.

In some cases, the one or more cooperative modes may include fourth cooperative mode, such as a second prediction mode, in which a first UE is delegated or configured to generate the prediction data for at least a second UE in the group of UEs 704. For example, in some cases, UE1 of the group of UEs 704 may be delegated to generate prediction data for one or more other UEs of the group of UEs 704, such as UE2, UE3, and/or UE4. In some cases, after generating the prediction data for the one or more other UEs of the group of UEs 704, UE1 may use UE-to-UE communication 706 (e.g., sidelink, Bluetooth, etc.) to transmit a report to the one or more other UEs including the prediction data.

In some cases, the one or more cooperative modes may include fifth cooperative mode, such as a third prediction mode, in which the group of UEs 704 are configured to generate the prediction data in a joint or distributed manner. For example, in some cases, each UE of the group of UEs 704 may have a different “partial” prediction model and input data may be processed in a distributed manner across the group of UEs 704. For example, in some cases, when generating the prediction data in the joint or distributed manner, signal measurements may first be processed by a first prediction model of a first UE, such as UE1, to generate first intermediate prediction data. In some cases, the signal measurements may be performed by UE1 itself (e.g., for one or more other UEs in the group of UEs 704 of UE1) and/or received from one or more other UEs in the group of UEs 704).

Thereafter, UE1 may then provide (e.g., via UE-to-UE communication) the first intermediate prediction data to a second UE, such as UE2, which may be used as an input to a second prediction model of UE2. For example, UE2 may be configured to process the first intermediate prediction data using the second prediction model to generate second prediction model, which may then be provided to a third UE, such as UE3. UE3 may then process the second intermediate prediction data using a third prediction model to generate third intermediate prediction data, which may be provided to a fourth UE, such as UE4. Finally, UE4 may process the third intermediate prediction data with a fourth prediction model to generate final predicted measurement data. In some cases, the final predicted measurement data may include prediction data for each respective UE of the group of UEs 704.

As discussed above, when cooperative-based operation is used, the group of UEs 704 may be configured to exchange signal measurements and/or prediction data with each other using UE-to-UE-based communication shown in FIG. 7, such as sidelink communication, Bluetooth communication, or the like. Additionally, as shown in FIG. 7, each of the UEs in the group of UEs 704 may also be configured to communicate directly with the network entity 702, as shown at 708, to receive configuration information for the cooperative-based operation from the network entity 702 and transmit measurement reports and/or prediction data to the network entity 702.

### Example Handshake Process for Cooperative-Based Operation

In some cases, when performing cooperative-based operation, the group of UEs 704 may engage in a handshake process. In some cases, the handshake process may include the exchange of one or more control messages and/or one or more data messages between the UEs of the group of UEs 704.

In some cases, the handshake process may be performed with full involvement from the network entity 702, partial involvement from the network entity 702, or no involvement from the network entity 702. For example, in some cases, when the network entity 702 has full involvement in the handshake process, the network entity 702 may be responsible for managing the cooperative-based operation between the group of UEs 704. For example, in this case, the network entity 702 may be responsible for determining configuration information for configuring the cooperative-based operation.

In some cases, the configuration information may include an indication of a cooperative operation mode for the group of UEs 704 to operate in and a set of measurement resources for performing the signal measurements. In some cases, the set of measurement resources include at least one of one or more frequencies on which to perform the signal measurements, one or more cells for which to perform the signal measurements, one or more reference signal types for which to perform the signal measurements, or a periodic time window for performing the signal measurements involving the exchange of control messages and data messages.

Accordingly, in some cases, when the network entity 702 is fully involved, the network entity 702 may select the cooperative mode in which the group of UEs 704 should operate in and may configure the set of measurement resources for performing the signal measurements. After determining the configuration information, the network entity 702 may then individually transmit the configuration information to each UE of the group of UEs 704 to configure the each of these UEs for the cooperative-based operation.

In some cases, with partial involvement, both the network entity 702 and one or more UEs of the group of UEs 704 may participate in the configuration of the cooperative-based operation. For example, in some cases, the network entity 702 may still be configured to determine the configuration information for the cooperative-based operation for the group of UEs 704, but instead of individually configuring each UE of the group of UEs 704, the network entity 702 may transmit the configuration information to a delegate UE of the group of UEs 704. The delegate UE may then generate group configuration information for the group of UEs 704. For example, based on the configuration information received from the network entity 702, the delegate UE may, in some cases, generate the group configuration information by selecting a particular cooperative mode or a subset a subset of measurement resources for the cooperative-based operation. Thereafter, the delegate UE may transmit the group configuration information to the group of UEs 704. Further, when the network entity 702 is only partially involved with the cooperative-based operation, the group of UEs 704 may still exchange the one or more control messages and the one or more data messages locally, using UE-to-UE-based communication, bypassing the network entity 702.

In some cases, with no involvement from the network entity 702, configuration of the cooperative-based operation may be managed completely by the group of UEs 704. For example, in some cases, when the network entity 702 is not involved, a delegate UE of the group of UEs 704 may be configured to determine group configuration information for the cooperative-based operation. In some cases, the group configuration information may include an indication of a cooperative mode in which the group of UEs 704 should operate in and a set of measurement resources for performing the signal measurements. The delegate UE may then transmit the group configuration information to the group of UEs 704, for example, using UE-to-UE-based communication (e.g., sidelink, Bluetooth, etc.).

In some cases, the one or more control messages that may be exchanged during the handshake process may include various information, such as a request for the cooperative-based operation, requesting that the group of UEs 704 collectively engage in the cooperative-based operation. For example, with reference to FIG. 7, in some cases, UE1 of the group of UEs 704 may transmit one or more control messages that requests UE2, UE3, and UE4 engage in the cooperative-based operation. In some cases, UE1 may directly transmit the one or more control messages to UE2, UE3, and UE4 using UE-to-UE-based communication or may transmit the one or more control messages to the network entity 702 for forwarding to UE2, UE3, and UE4.

In some cases, the one or more control messages may include response information responding to a request for the cooperative-based operation. For example, in some cases, in response to receiving the request for the cooperative-based operation (e.g., from UE1), UE2, UE3, and UE4 may each send a control message back to UE1 with response information that either accepts or denies the request for the cooperative-based operation requested by UE1. In some cases, the control messages including the response information may directly transmitted to UE1 using UE-to-UE-based communication or may be transmit the network entity 702 for forwarding to UE1.

In some cases, the one or more control messages may include the configuration information for configuring the cooperative-based operation. For example, as noted above, the configuration information may indicate a cooperative operation mode for the group of UEs 704 to operate in and a set of measurement resources for performing the signal measurements. In some cases, the set of measurement resources include at least one of one or more frequencies on which to perform the signal measurements, one or more cells for which to perform the signal measurements, one or more reference signal types for which to perform the signal measurements, or a periodic time window for performing the signal measurements involving the exchange of control messages and data messages.

In some cases, the one or more control messages may include UE capability information indicating which cooperative modes of the one or more cooperative modes that a UE of the group of UEs 704 supports. As an example, UE1 in FIG. 7 may transmit one or more control messages, to at least one of UE2, UE3, or UE4, including UE capability information that indicates which cooperative modes that UE1 supports (e.g., the measurement delegation mode, the measurement collaboration mode, the first prediction mode, etc.). In some cases, the UE capability information statically indicates which cooperative modes of the one or more cooperative modes that UE1 supports. In other words, the statically indicated cooperative modes may include cooperative modes that UE1 can always support. In some cases, the UE capability information may dynamically indicate which cooperative modes of the one or more cooperative modes that UE1 supports. For example, in some cases, UE1 may be capable of different cooperative modes at different times or different locations. In such cases, the UE capability information may indicate that UE1 is capable of a particular cooperative mode at a particular time or location. In some cases, at a different point in time or location, UE1 may transmit additional UE capability information that indicates support for a different cooperative mode.

In some cases, the UE capability information may also be transmitted to the network entity 702, which may use the UE capability information when determining the configuration information for the cooperative-based operation (e.g., for selecting the cooperative mode and/or selecting the set of measurement resources).

In some cases, the one or more control messages may include an indication of a UE of the group of UEs 704 that is selected as a delegate UE for the group of UEs 704 for at least one of performing signal measurements or generating prediction data based on the signal measurements. In some cases, the delegate UE may be selected based on the UE capability information. For example, in some cases, UE1 may receive at least one control message from UE2, UE3, UE4, or the network entity 702 selecting or designating UE1 as a delegate UE for the group of UEs 704. When selected or designated as the delegate UE, UE1 may perform signal measurements for one or more other UEs of the group of UEs 704 or may generate prediction data for the one or more other UEs. Thereafter, UE1 may transmit, to the one or more other UEs, one or more data messages including a report indicating the signal measurements that UE1 performed for the one or more other UEs and/or the prediction data that UE1 generated for the one or more other UEs.

In some cases, the one or more control messages may include update information for the cooperative-based operation. For example, in some cases, the update information may include an indication to enable or disable the cooperative-based operation, an updated cooperative mode to use for the cooperative-based operation, updated configuration information.

In some cases, the handshake process may also include the exchange of one or more data messages between the UEs of the group of UEs 704. For example, in some cases, the one or more data messages may include signal measurements performed at one or more UEs of the group of UEs 704, prediction data generated at the one or more UEs of the group of UEs 704, and/or performance metrics associated with the prediction data generated at the one or more UEs of the group of UEs 704 and/or associated with a prediction model of the one or more UEs.

### Example Measurement Calibration

As discussed above, one or more UEs of the group of UEs 704 may be selected or designated as a delegate UE to perform signal measurements for one or more other UEs of the group of UEs 704. As an example, UE1 in FIG. 7 may be selected or designated as a delegate UE for performing signal measurements for at least of UE2 in FIG. 7. Accordingly, when UE1 is selected as the delegate UE, UE1 may perform signal measurements (e.g., RSRP, RSRQ, SINR, CQI, etc. of one or more RSs transmitted by the network entity 702) for UE2, which may then be transmitted (e.g., in one or more data messages) to UE2 for use in measurement reporting by UE2 and/or in generating prediction data at UE2. However, because the signal measurements are performed at UE1 rather than UE2, these signal measurements may not accurately represent what the signal measurements would have been had they been performed by UE2, which may lead to negative effects, such as inaccurate prediction data, inefficient network resource allocation, poor handover decisions, and reduced overall network performance.

Accordingly, in some cases, to improve the accuracy of signal measurements when these measurements are performed by a delegate UE for another UE within the group of UEs 704, a calibration process may be performed on these measurements. For example, this calibration process may involve adjusting the signal measurements performed at UE1 to be representative of signal measurements that would have been performed by UE2. In some cases, the calibration process may be performed by the UE for which the signal measurements were performed (e.g., by UE2 in this example), by the delegate UE (e.g., UE1), or by the network entity 702.

In some cases, the calibration process may be performed based on a set of calibration parameters that may allow the entity performing the calibration process to adjust the signal measurements to be representative of signal measurements that would have been performed by UE2. In some cases, the set of calibration parameters may include parameters indicating a history of measurement results for a historic period of time T, where T may be configurable by the network entity 702. In some cases, parameters indicating a history of measurement results may include an indication of an RS type (e.g., SSB, CSI-RS, etc.) of signal measurements performed by the UE2 corresponding to the historic period of time and the signal measurements performed by the second UE corresponding to the historic period of time.

In some cases, the set of calibration parameters may include parameters indicating a history of prediction data for the historic period of time. For example, the parameters indicating the history of the prediction data may include an indication of a RS type (e.g., SSB, CSI-RS, etc.) corresponding to prediction data generated by UE2 corresponding to the historic period of time as well as the prediction data generated by UE2 corresponding to the historic period of time.

In some cases, the set of calibration parameters may include geographical information associated with UE2 (e.g., at a time when the signal measurements were performed by the delegate UE/UE1). In some cases, the geographical information may include an indication of a location of UE2, an indication of an altitude of UE2, an indication of a direction in which the UE2 is facing, an indication of a blockage between UE2 and the network entity 702 In some cases, the set of calibration parameters may also include a timestamp for the geographical information associated with UE2.

In some cases, the set of calibration parameters may include an indication of a signal condition associated with UE2 including one of a line-of-sight (LoS) condition or non-line-of-sight (NLoS) condition. For example, the signal condition may indicate whether RS are received at UE2 from the network entity 702 via the LoS condition or the NLoS condition. In some cases, the set of calibration parameters may also include a timestamp associated with the indicated signal condition.

As noted above, in some cases, the calibration process may be performed by UE2, UE1, or the network entity 702. In some cases, when UE1 performs the calibration process on the signal measurements performed for UE2, UE1 may receive the set of calibration parameters from UE2. UE1 may then perform the calibration process on the signal measurements that it performed for UE2 based on the set of calibration parameters received from UE2. Thereafter, UE1 may be configured to transmit the calibrated signal measurements to UE2 for measurement reporting (e.g., transmission in a measurement report by UE2 to the network entity 702) or further processing (e.g., generation of prediction data by UE2).

In some cases, when the network entity 702 performs the calibration process, the network entity 702 may receive the signal measurements performed for UE2 from UE1 (e.g., in a measurement report) and may also receive the set of calibration parameters from UE2. The network entity 702 may then perform the calibration process on the signal measurements performed for UE2 based on the set of calibration parameters received from UE2. Thereafter, the network entity 702 may be configured to transmit the calibrated signal measurements to UE2 for further processing (e.g., generation of prediction data by UE2).

### Example Prediction Model Configuration

As discussed above, in some cases, when performing cooperative-based operation, the group of UE 704 may use one or more prediction models to cooperatively generate prediction data based on signal measurements that are performed by one or more UEs of the group of UEs. In some cases, the prediction data may include predicted signal measurements (e.g., predicted RSRP, RSRQ, etc.) of one or more RSs in the future. In some cases, the prediction data may include predicted signal measurements of RSs associated with one or more communication beams for which signal measurements were not performed (e.g., predicted signal measurements for a first communication beam generated based on signal measurements performed for a second communication beam). In some cases, the prediction data may include a predicted rate of change of signal measurements over time. In some cases, the prediction data may include a predicted event, such as a cell switch (e.g., a layer 3 (L3) handover, lower layer triggered mobility (LTM), etc.), a radio link failure (RLF), and/or a beam failure detection (BFD).

In some cases the one or more prediction models for generating the prediction data may be configured in different manners. For example, in some cases, the one or more prediction models may be transmitted to the group of UEs 704 using a broadcast or multicast message by a subset of UEs of the group of UEs 704. For example, in some cases, the subset of UEs may comprise UEs of the group of UEs 704 that have been selected or designated as delegate UEs, such as UE1 in FIG. 7. In some cases, UE1 may receive (e.g., download) the one or more prediction models from the network entity 702 or the one or more prediction models may be preconfigured in memory of UE1 by a manufacturer or distributor of UE1. Thereafter, UE1 may be configured to use UE-to-UE-based communication to transmit a broadcast or multicast message, to the one or more prediction models to other UEs in the group of UEs 704, such as UE2, UE3, and/or UE4. In some cases, UE1 may transmit the one or more prediction models using a broadcast or multicast message. In some cases, the delegate UEs, including UE1, may also be responsible managing the performance of the one or more prediction models as well as for life cycle management (LCM).

In some cases, the one or more prediction models may be transmitted to the group of UEs 704 by the network entity 702 using one or more broadcast or multicast messages. In some cases, the network entity 702 may be triggered to transmit the one or more prediction models to the group of UEs 704 based on a request from a delegate UE of the group of UEs 704. For example, in some cases, UE1 may transmit a request to the network entity 702 that requests the network entity 702 to transmit the one or more prediction models to the group of UEs 704. Thereafter, based on the request, the group of UEs 704 (e.g., UE1, UE2, UE3, and UE4) may then receive the one or more prediction models from the network entity 702 in the one or more broadcast or multicast messages.

In some cases, the network entity 702 may be configured to transmit the same prediction model to each UE in the group of UEs 704. For example, in this case, each UE of the group of UEs 704 may be configured to use the same prediction model with different UE-specific input data. In other words, each UE of the group of UEs 704 may use the same prediction model but may each use different respective signal measurements. For example, UE1 may use signal measurements corresponding to UE1 as an input to the prediction model while UE2 may use signal measurements corresponding to UE2 as an input to the same prediction model.

In some cases, when the group of UEs 704 are configured to generate the prediction data in a joint or distributed manner, the network entity 702 may be configured to transmit different (partial) prediction models to each of the UEs in the group of UEs 704. For example, the UE1 may receive a first prediction model from the network entity 702 and UE2 may receive a second prediction model from the network entity 702. UE1 and UE2 may then generate prediction data in the joint or distributed manner using the first prediction model and the second prediction model, respectively. Additional details regarding the manners in which the group of UEs 704 may generate prediction data are provided below.

As described above, in some cases, a fourth cooperative mode may be used for cooperative-based operation in which a delegate UE generates prediction data for another UE. For example, when using the fourth cooperative mode, UE1 may be configured to generate prediction data for UE2. In such cases, UE1 may also be configured to generate prediction data for itself. In some cases, when generating the prediction data for the UE2, UE1 may be configured to use a different prediction model than a prediction model that used for generating the prediction data for itself. Accordingly, in some cases, in order to generate the prediction data for itself and for UE2, UE1 may be configured to receive, from the network entity 702, a first prediction model for generating the prediction data for UE2 as well as a second prediction model for generating the prediction data for UE2.

### Example Prediction Data Generation

In some cases, the group of UEs 704 may be configured to generate prediction data in different manners, for example, depending on the cooperative mode used for the cooperative-based operation.

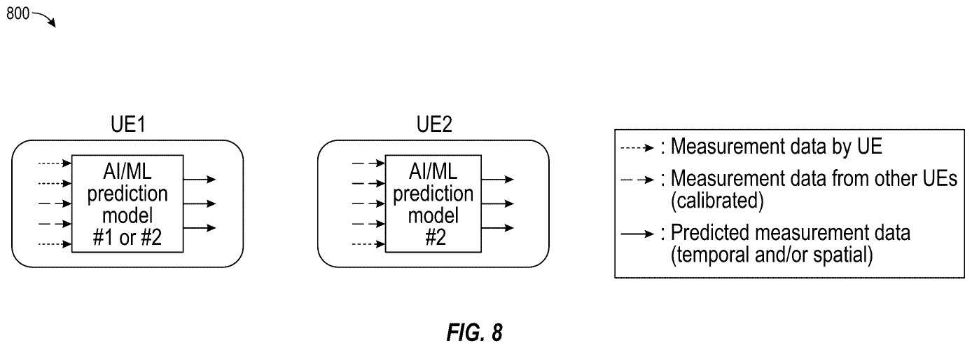

FIG. 8 illustrates a first manner 800 in which prediction data may be generated by the group of UEs 704, for example, according the third cooperative mode (e.g., first prediction mode) in which each UE of the group of UEs 704 is configured to individually generate prediction data for itself based on signal measurements that that UE performed for itself and/or based on signal measurements that another UE in the group of UEs 704 performed for that UE. For example, as shown in FIG. 8, each of UE1 and UE2 of FIG. 7 may be configured with a prediction model for generating prediction data. In some cases, both UE1 and UE2 may use the same prediction model (e.g., prediction model #2) or may use different prediction models (e.g., UE1 uses prediction model #1 while UE2 uses prediction model #2).

Further, as shown, UE1 may be configured to generate prediction data (e.g., temporal-or spatial-based predicted measurement data) by inputting, into prediction model #1 or prediction model #2, signal measurements performed by UE1 for UE1. Further, in some cases, UE1 may receive, from one or more other UEs in the group of UEs 704, signal measurements performed by the one or more other UEs for UE1. In such cases, UE1 may also generate the prediction data by inputting, into prediction model #1 or prediction model #2, the signal measurements performed by the one or more other UEs for UE1 (e.g., after these signal measurements have been calibrated for UE1 either by UE1 or by the one or more other UEs). In some cases, UE1 may be configured to generate the prediction data by inputting, into prediction model #1 or prediction model #2, only the signal measurements that UE1 performed or only the signal measurements that the one or more other UEs performed.

Similarly, as shown, UE2 may be configured to generate prediction data (e.g., temporal-or spatial-based predicted measurement data) by inputting, into prediction model #2, signal measurements performed by UE2 for UE2 and/or signal measurements performed by one or more other UEs in the group of UEs 704 for UE2 (e.g., after these signal measurements have been calibrated for UE2 either by UE2 or by the one or more other UEs).

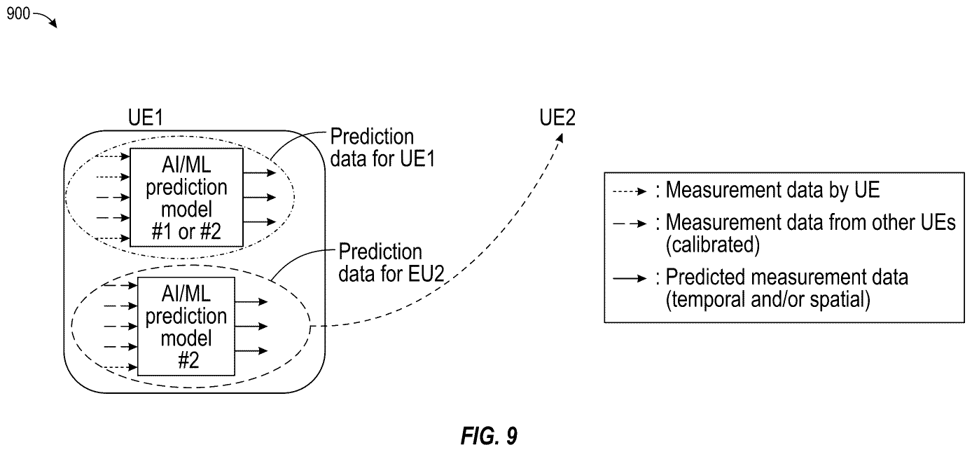

FIG. 9 illustrates a second manner 900 in which prediction data may be generated by the group of UEs 704, for example, according the fourth cooperative mode (e.g., second prediction mode) in which a first UE is delegated or configured to generate the prediction data for at least a second UE in the group of UEs 704. For example, as shown in FIG. 9, UE1 of FIG. 7 may be delegated to generate prediction data for UE2 as well as being configured to generate prediction data for itself. In some cases, UE1 may be use the same prediction model (e.g., prediction model #2) for generating the prediction data for UE1 and for generating the prediction data for UE2. In other cases, UE1 may use different prediction models for generating the prediction data for UE1 and for generating the prediction data for UE2. For example, in some cases, UE1 may use prediction model #1 for generating the prediction data for UE1 and may use prediction model #2 for generating the prediction data for UE2.

Further, as shown, UE1 may be configured to generate prediction data for UE1 (e.g., temporal-or spatial-based predicted measurement data) by inputting, into prediction model #1 or prediction model #2, signal measurements performed by UE1 for UE1. Further, in some cases, UE1 may receive, from one or more other UEs in the group of UEs 704, signal measurements performed by the one or more other UEs for UE1. In such cases, UE1 may also generate the prediction data for UE1 by inputting, into prediction model #1 or prediction model #2, the signal measurements performed by the one or more other UEs for UE1 (e.g., after these signal measurements have been calibrated for UE1 either by UE1 or by the one or more other UEs).

Similarly, as shown, UE1 may also be configured to generate prediction data for UE2 (e.g., temporal-or spatial-based predicted measurement data) by inputting, into prediction model #2, signal measurements performed by UE1 for UE2 (e.g., after these signal measurements have been calibrated for UE2 by UE1). Further, in some cases, UE1 may receive, from one or more other UEs in the group of UEs 704, signal measurements performed by the one or more other UEs for UE2. In such cases, UE1 may also generate the prediction data for UE2 by inputting, into prediction model #2, the signal measurements performed by the one or more other UEs for UE2 (e.g., after these signal measurements have been calibrated for UE2 either by UE1 or by the one or more other UEs, if necessary). Thereafter, as shown, UE1 may transmit, to UE2, the prediction data generated for UE2, for example, in one or more data messages, as described above.

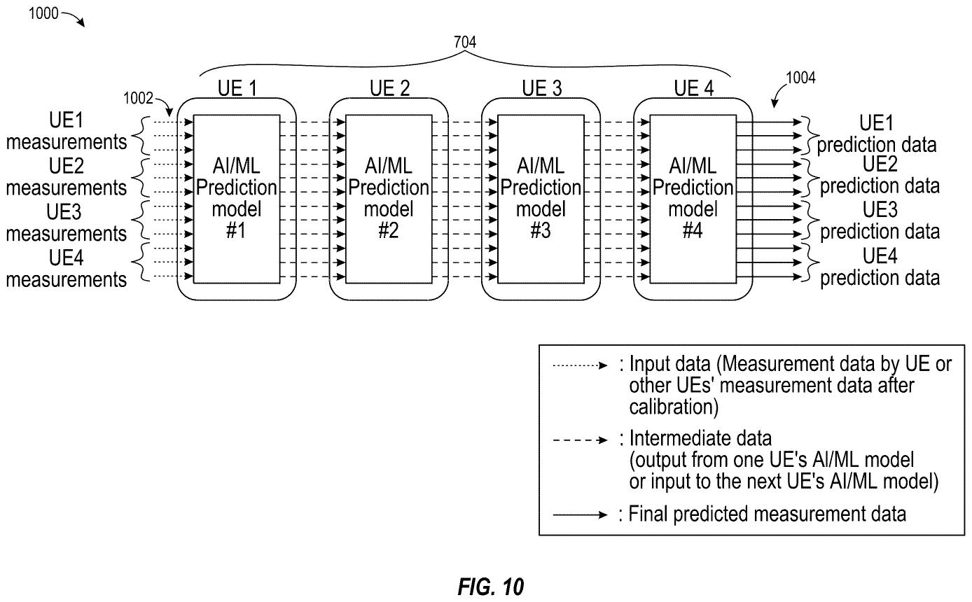

FIG. 10 illustrates a third manner 1000 in which prediction data may be generated by the group of UEs 704, for example, according the fifth cooperative mode (e.g., third prediction mode) in which the group of UEs 704 are configured to generate the prediction data in a joint or distributed manner. For example, in some cases, each UE of the group of UEs 704 may be configured with a different “partial” prediction model and input data may be processed in a distributed manner across the group of UEs 704. For example, UE1 may be configured with prediction model #1, UE2 may be configured with prediction model #2, and UE3 may be configured with prediction model #3, and UE4 may be configured with prediction model #4. While FIG. 10 illustrates four UEs involved in generating prediction data in the joint or distributed manner, it should be appreciated that any number (e.g., N) of UEs may be involved in generating prediction data in the joint or distributed manner.

In order to generate the prediction data in the joint or distributed manner, the UE1 may first obtain signal measurements for each of UE1, UE2, UE3, and UE4 in the group of UEs 704. In some cases, obtaining the signal measurements for each of the UEs in the group of UEs 704 may include UE1 performing the signal measurements for UE1, UE2, UE3, and UE4, receiving the signal measurements for UE2, UE3, and UE4, or a combination (e.g., UE1 receiving the signal measurements from UE3 and UE4 while UE1 also performing the signal measurements for UE1 and UE2).

UE1 may then aggregate the signal measurements for each of the UEs in the group of UEs 704 to generate aggregated signal measurements 1002. Thereafter, UE1 may input the aggregated signal measurements 1002 into prediction model #1 to generate first intermediate prediction data. UE1 may then transmit a report (e.g., in one or more data messages) to UE2 including the first intermediate prediction data to be further input into the prediction model #2 by UE2. For example, after receiving the first intermediate prediction data, UE2 may input the first intermediate prediction data into prediction model #2 to generate second intermediate prediction data.

UE2 may then transmit a report (e.g., in one or more data messages) to UE3 including the second intermediate prediction data to be further input into the prediction model #3 by UE3. For example, after receiving the second intermediate prediction data, UE3 may input the second intermediate prediction data into prediction model #3 to generate third intermediate prediction data.

UE3 may then transmit a report (e.g., in one or more data messages) to UE4 including the third intermediate prediction data to be further input into the prediction model #4 by UE4. As can be seen in FIG. 10, the third intermediate prediction data includes prediction data generated (e.g., by UE1 based on prediction model #1, UE2 based on prediction model #2, and UE3 based on prediction model #3) based on the aggregated signal measurements 1002 associated each of the UEs in the group of UEs 704.

After receiving the third intermediate prediction data, UE4 may input the third intermediate prediction data into prediction model #4 to generate final prediction data 1004. As can be seen, because the final prediction data 1004 is generated in a distributed manner, the final prediction data 1004 may include prediction data for each of the UEs in the group of UEs 704. For example, the final prediction data 1004 may include first prediction data for UE1, second prediction data for UE2, third prediction data for UE3, and fourth prediction data for UE4. Thereafter, in some cases, UE4 may then transmit the final prediction data 1004 to each UE in the group of UEs 704. In some cases, rather than transmitting the full, final prediction data 1004 to each of these UEs, UE4 may transmit only a portion of the final prediction data 1004 to each individual UE of the group of UEs 704. For example, UE4 may transmit the first prediction data to UE1, the second prediction data to UE2, and the third prediction data to UE3.

### Example Prediction Model Performance Monitoring

In some cases, when using cooperative-based operation, the network entity 702 and/or one or more of the UEs of the group of UEs 704 may be configured to monitor performance of the cooperative-based signal measurements and/or the cooperative-based prediction data generation. In other words, at least one of the network entity 702 or one or more UEs of the group of UEs 704 may be configured to monitor the performance associated with the prediction data that is cooperatively generated among the group of UEs, using one or more prediction models, based on cooperatively-performed signal measurements. For example, performance monitoring may provide an indication regarding how well the prediction data that is cooperatively generating using the one or more prediction models matches signal measurements in the future corresponding to the cooperatively-generated prediction data.

For example, in some cases, the prediction data generated by one or more of the UEs of the group of UEs 704, such as UE1, may be generated at a first period of time and may comprise a predicted signal measurement(s) for a signal for a second period of time that occurs after the first period of time. In other words, the prediction data, which may be generated based on signal measurements performed in the past, may include predicted signal measurements for a future point in time relative to when the signal measurements were performed and when prediction data is generated.

In some cases, UE1 may be configured to periodically monitor the performance associated with the prediction data collaboratively generated based on the signal measurements performed by the group of UEs 704. For example, in some cases, UE1 may be configured to determine a performance metric associated with the prediction data. In some cases, the performance metric may be based on, or represent, a difference between a predicted signal measurement for a signal and an actual signal measurement for that signal. For example, in some cases, after generating the prediction data including the predicted signal measurement for a signal at the first period of time, UE1 may thereafter perform an actual signal measurement for that signal at the second period of time. UE1 may then determine the performance metric by evaluating a difference between the predicted signal measurement for the signal and the actual signal measurement for that signal.

In some cases, when designated or selected as a delegate UE, UE1 may also monitor the performance associated with prediction data generated by other UEs in the group of UEs 704. For example, in some cases, UE1 may be configured to receive the prediction data for the one or more other UEs in the group of UEs 704, including predicted signal measurements for one or more signals. UE1 may also receive the signal measurements for the one or more signals performed by the one or more other UEs in the group of UEs 704. UE1 may then determine the performance metric by evaluating the difference between the predicted signal measurements for the one or more signals received from the one or more other UEs in the group of UEs 704 and the signal measurements for the one or more signals received from the one or more other UEs in the group of UEs 704.

In some cases, UE1 may receive, from the network entity 702, one or more criteria for determining the performance metric. For example, in some cases, the one or more criteria may include a measurement correlation criterion associated with the signal measurements associated with the group of UEs 704. For example, the measurement correlation criterion may indicate how collocated the UEs in the group of UEs 704 are or how correlated the signal measurements performed by each of the UEs in the group of UEs 704 are.

In some cases, the one or more criteria may include a geographical correlation criterion associated with UEs in the group of UEs 704. For example, in some cases, the geographical criterion may include a location of UEs in the group of UEs 704 (e.g., a two-dimensional or three-dimensional location criterion), a speed of UEs in the group of UEs 704, and/or a trajectory of UEs in the group of UEs 704.

In some cases, the one or more criteria may include a channel quality or signal strength criterion associated with the signal measurements performed by the group of UEs 704, such as RSRP, RSRQ, SINR, RSSI of the signal measurements, performed by the group of UEs 704, associated with a serving cell or a neighboring cell.

In some cases, UE1 may be configured to transmit, to the network entity 702, a performance report indicating the performance metric when one or more conditions are satisfied. For example, in some cases, the one or more conditions for transmitting the performance report may comprise the performance metric being greater than or equal to an error threshold, such threshold mean absolute error. In some cases, UE1 may transmit the performance report to the network entity 702 using a layer 1 (L1) or layer 3 (L3) based measurement report or may be transmitted using new L1- or L3-based signaling.

In some cases, as noted above, the network entity 702 may be configured to perform performance monitoring. For example, in some cases, the network entity 702 may request all or a subset (e.g., a delegate UE) to send, to the network entity 702, performance reporting information that indicates a history of signal measurements performed by each UE in the group of UEs 704, calibrated (or non-calibrated) signal measurements performed for that UE by other UEs in the group of UEs 704, and/or prediction data generated by each of the UEs in the group of UEs 704. As an example, based on the request from the network entity 702, UE1 may be configured to transmit a report that indicates signal measurements performed by UE1 for UE1, calibrated or non-calibrated signal measurements performed for UE1 by one or more other UEs in the group of UEs 704, and prediction data generated based on the signal measurements. The network entity 702 may then determine a performance metric based on the performance reporting information from one or more of the UEs in the group of UEs 704.

In some cases, when the performance metric reported by UE1 in the performance report or determined by the network entity is less than or equal to a particular performance threshold associated with the cooperative-based operation, the network entity 702 may transmit, to the group of UEs 704, an indication to stop the cooperative-based operation and to fall back to normal operation.

### Example Operations of Entities in a Communications Network

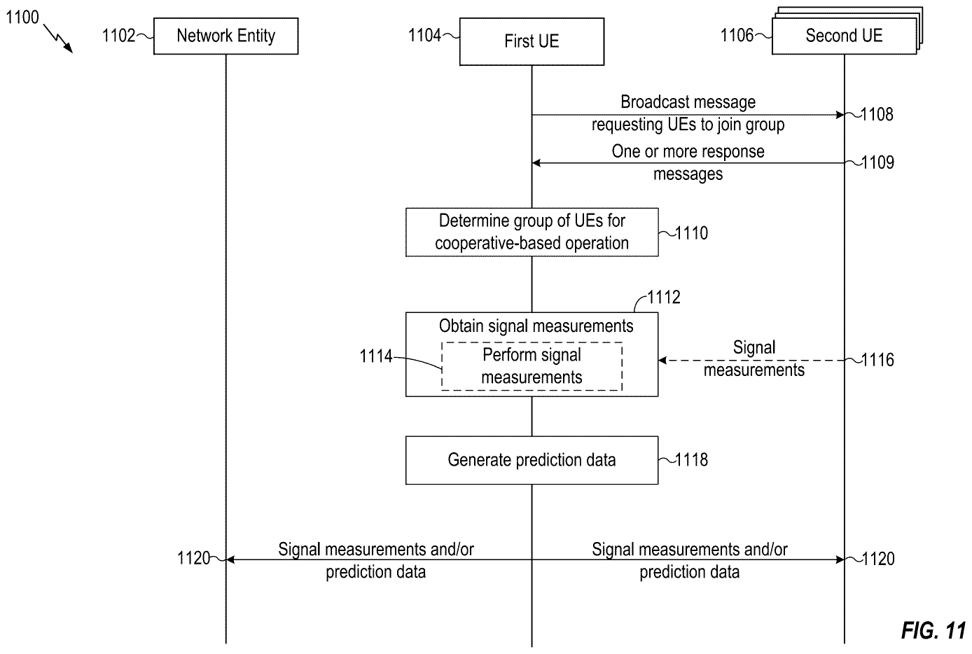

FIG. 11 depicts a process flow including operations 1100 for cooperative-based operation including cooperatively performed signal measurements and cooperatively-generated prediction data, according to the techniques presented above. As shown, operations 1100 may involve one or more entities in network, such as a network entity 1102, a first UE 1104 and one or more second UEs 1106. In some aspects, the network entity 1102 may be an example of the BS 102 depicted and described with respect to FIGS. 1 and 3, a disaggregated base station depicted and described with respect to FIG. 2, and/or the network entity 702 depicted and described with respect to FIGS. 7-10. Additionally, the first UE 1104 may be an example of UE 104 depicted and described with respect to FIGS. 1 and 3 and/or UE1 depicted and described with respect to FIGS. 7-10. Similarly, the one or more second UEs 1106 may be an examples of UE 104 depicted and described with respect to FIGS. 1 and 3 and/or UE2, UE3, or UE4 depicted and described with respect to FIGS. 7-10.

It should be appreciated that operations 1100 described with reference to FIG. 11 are presented in a particular order for illustrative purposes. However, unless explicitly stated otherwise, it should be appreciated that operations 1100 are not required to be performed in the specific order shown in FIG. 11 and may be performed in a different order, in parallel, or omitted, as appropriate, without departing from the scope of the disclosure. Additionally, the numbering of the operations and corresponding reference numbers should not be construed as requiring any particular order of performance.

As shown at 1110, the first UE 1104 may determine or form a group of UEs for cooperative-based operation in which at least one of signal measurements are cooperatively performed among the group of UEs or prediction data is cooperatively generated among the group of UEs. As an example, the group of UEs may include the first UE 1104 and the one or more second UEs 1106 of FIG. 11.

In some cases, to determine the group of UEs, the first UE 1104 may transmit a broadcast message requesting for one or more UEs to join the group of UEs, as shown at 1108. Thereafter, at 1109, the first UE 1104 may then receive, from the one or more second UEs 1106, one or more response messages accepting the request to join the group of UEs. In some cases, the first UE 1104 may then determine the group of UEs based on the one or more response messages. For example, the group of UEs may include the one or more second UEs 1106 for which the one or more response messages have been received by the first UE 1104.

At 1112, the first UE 1104 may obtain, according to the cooperative-based operation, signal measurements for one or more signals. As shown at 1114, obtaining the signal measurements for the one or more signals may include the first UE 1104 performing the signal measurements for the one or more signals. As shown at 1116, obtaining the signal measurements for the one or more signals may include the first UE 1104 receiving the signal measurements for the one or more signals from the one or more second UEs 1106.

At 1118, the first UE 1104 may generate, according to the cooperative-based operation, prediction data by inputting the signal measurements into one or more prediction models.

At 1120, the first UE 1104 may transmit, to at least one of the network entity 1102 or the one or more second UEs 1106, a report indicating at least one of the signal measurements or the prediction data.

In some cases, the cooperative-based operation includes one or more cooperative modes. In some cases, the one or more cooperative modes may include a measurement delegation mode in which the UE operates as a delegate UE to perform signal measurements on behalf of one or more UEs of the group of UEs. In some cases, the one or more cooperative modes may include a measurement collaboration mode in which each UE of the group of UEs performs a different subset of signal measurements and the different subsets of signal measurements are aggregated together by one UE of the group of UEs. In some cases, the one or more cooperative modes may include a first prediction mode in which the UE is configured to generate the prediction data based on the signal measurements resulting from the measurement delegation mode or the measurement collaboration mode. In some cases, the one or more cooperative modes may include a second prediction mode in which the UE is configured to generate the prediction data for at least a second UE in the group of UEs. In some cases, the one or more cooperative modes may include a third prediction mode in which the group of UEs, including the UE, are configured to generate the prediction data in a joint manner.

In some cases, the first UE 1104 may transmit UE capability information indicating which cooperative modes of the one or more cooperative modes that the first UE 1104 supports. In some cases, the UE capability information statically indicates which cooperative modes of the one or more cooperative modes that the first UE 1104 supports or may dynamically indicate which cooperative modes of the one or more cooperative modes that the first UE 1104 supports. In some cases, the first UE 1104 may transmit the UE capability information to the network entity 1102. In some cases, the first UE 1104 may transmit the UE capability information to the one or more second UEs 1106.

In some cases, the first UE 1104 may transmit, to the network entity 1102, a message requesting the cooperative-based operation according to at least one cooperative mode of the one or more cooperative modes. In some cases, the first UE 1104 may receive, from the network entity 1102 based on the request for the cooperative-based operation, configuration information configuring the at least one cooperative mode. In some cases, the configuration information may indicate a cooperative operation mode, of the one or more cooperative modes indicated in the UE capability information, for the UE to operate in and a set of measurement resources for performing the signal measurements. In some cases, the set of measurement resources include at least one of one or more frequencies on which to perform the signal measurements, one or more cells for which to perform the signal measurements, one or more reference signal types for which to perform the signal measurements or a periodic time window for performing the signal measurements.

In some cases, the first UE 1104 may generate, based on the configuration information received from the network entity, group configuration information indicating a subset of measurement resources for configuring the cooperative-based operation for the group of UEs. In some cases, the first UE 1104 may transmit, to the one or more second UEs 1106 in the group of UEs, the group configuration information indicating the subset of measurement resources for configuring the cooperative-based operation.

In some cases, the first UE 1104 may receive, from the one or more second UEs 1106 in the group of UEs based on the UE capability information, a message requesting the cooperative-based operation according to at least one cooperative mode of the one or more cooperative modes. In some cases, the first UE 1104 may transmit a response message acknowledging the requested at least one cooperative mode. In some cases, the first UE 1104 may determine group configuration information indicating measurement resources for configuring the at least one cooperative mode for the group of UEs. In some cases, the first UE 1104 may determine the group configuration information without involvement from the network entity 1102. In some cases, the first UE 1104 may transmit, to the one or more second UEs 1106 in the group of UEs, the group configuration information indicating the measurement resources for configuring the at least one cooperative mode.

In some cases, the first UE 1104 may receive, from the network entity 1102 or the one or more second UEs 1106 in the group of UEs, a message indicating that the first UE has been selected as a delegate UE for the cooperative-based operation. In some cases, based on the first UE 1104 being selected as the delegate UE, the first UE 1104 may generate prediction data at 1118 for the one or more second UEs 1106 in the group of UEs. In some cases, transmitting the report at 1120 may include the first UE 1104 comprises transmitting the report to the one or more second UEs 1106 including the prediction data generated by the first UE 1104 for the one or more second UEs 1106.

In some cases, based on the first UE 1104 being selected as the delegate UE, obtaining the signal measurements for the one or more signals at 1112 comprises performing, at 1114, the signal measurements for the one or more second UEs 1106 in the group of UEs. In some cases, when the first UE 1104 performs the signal measurements for the one or more second UEs 1106, the first UE 1104 may perform a calibration process on the signal measurements for the one or more second UEs 1106. For example, in some cases, the first UE 1104 may calibrate the signal measurements performed at the first UE 1104 for the one or more second UEs 1106, which may involve adjusting the signal measurements performed at the first UE 1104 to be representative of signal measurements that would have been performed by the one or more second UEs 1106.

In some cases, the first UE 1104 may receive a set of calibration parameters from the second UE. In some cases, the first UE 1104 may calibrate the signal measurements performed for the one or more second UEs 1106 based on a set of calibration parameters received from the one or more second UEs 1106. In some cases, the set of calibration parameters include at least one of: an indication of a reference signal type of signal measurements performed by the one or more second UEs 1106 corresponding to a historic period of time, signal measurements performed by the one or more second UEs 1106 corresponding to a historic period of time, an indication of a reference signal type corresponding to prediction data generated by the one or more second UEs 1106 corresponding to a historic period of time, prediction data generated by the one or more second UEs 1106 corresponding to a historic period of time, an indication of a location of the one or more second UEs 1106, an indication of an altitude of the one or more second UEs 1106, an indication of a direction in which the one or more second UEs 1106 is facing, an indication of a blockage between the one or more second UEs 1106 and a network entity, or an indication of a signal condition associated with the one or more second UEs 1106 including one of a line-of-sight (LoS) condition or non-line-of-sight (NLoS) condition.

In some cases, the signal measurements for one or more signals are performed at the one or more second UEs 1106. In such cases, obtaining signal measurements for the one or more signals at 1112 may include the first UE 1104 receiving the signal measurements for the one or more signals from the one or more second UEs 1106, as shown at 1116. In some cases, the first UE 1104 may calibrate, based on a set of calibration parameters associated with the first UE 1104, the signal measurements performed at the one or more second UEs 1106 for the first UE 1104. In some cases, calibrating the signal measurements performed at the one or more second UEs 1106 adjusts the signal measurements performed at the one or more second UEs 1106 to be representative of signal measurements that would have been performed by the first UE 1104.

In some cases, the first UE 1104 may transmit, to the one or more second UEs 1106, a set of calibration parameters associated with the first UE 1104 for calibrating the signal measurements performed at the one or more second UEs 1106 for the first UE 1104. In such cases, the signal measurements received from the one or more second UEs 1106 at 1116 are calibrated at the one or more second UEs 1106 based on the set of calibration parameters associated with the first UE 1104 that are transmitted to the one or more second UEs 1106.

In some cases, the first UE 1104 may receive the one or more prediction models in a broadcast or multicast message from the one or more second UEs 1106 in the group of UEs. In some cases, the one or more prediction models are preconfigured in memory of the first UE by a manufacturer or distributor of the first UE. In some cases, the one or more prediction models are received from the network entity 1102. In some cases, when the one or more prediction models are either preconfigured at the first UE 1104 or received from the network entity 1102, the first UE 1104 may transmit the one or more prediction models in a broadcast or multicast message to the one or more second UEs 1106 in the group of UEs.

In some cases, the first UE 1104 may transmit, to the network entity 1102, a request for the network entity 1102 to transmit the one or more prediction models to the group of UEs, including the first UE 1104 and the one or more second UEs 1106. Thereafter, the first UE 1104 (and the one or more second UEs 1106) may receive the one or more prediction models from the network entity 1102 based on the request.

In some cases, the one or more prediction models received by the first UE 1104 may comprise at least a first prediction model for the first UE 1104 and a second prediction model for the one or more second UEs 1106. In some cases, the first prediction model from the first UE is the same as the second prediction model for the second UE. In some cases, the first prediction model for the first UE is different from the second prediction model for the second UE

In some cases, obtaining the signal measurements for the one or more signals at 1112 may include performing the signal measurements for the one or more signals, as shown at 1114. In some cases, generating the prediction data at 1118 may include generating the prediction data by inputting the signal measurements into the first prediction model for the first UE 1104.

In some cases, in accordance with FIG. 8, obtaining the signal measurements for the one or more signals at 1112 may further comprise receiving the signal measurements for the one or more signals from the one or more second UEs 1106. In such cases, the signal measurements for the one or more signals received from the one or more second UEs 1106 are performed by the one or more second UEs 1106 for the first UE 1104. In some cases, generating the prediction data at 1118 may further comprises generating the prediction data by inputting the signal measurements received from the one or more second UEs 1106 into the first prediction model for the first UE 1104 with the signal measurements performed by the first UE 1104. In some cases, the signal measurements received from the one or more second UEs 1106 are calibrated for the first UE 1104 by the one or more second UEs 1106 prior to being received by the first UE 1104. In some cases, the signal measurements received from the one or more second UEs 1106 are calibrated for the first UE 1104 by the first UE 1104 prior to being inputted into the first prediction model for the first UE 1104.

In some cases, obtaining the signal measurements for the one or more signals at 1112 may include receiving the signal measurements for the one or more signals from the second UE, as shown at 1116. In some cases, generating the prediction data at 1118 may include the first UE 1104 generating the prediction data by only inputting the signal measurements received from the one or more second UEs 1106 into the first prediction model for the first UE. In some cases, the signal measurements received from the one or more second UEs 1106 are calibrated for the first UE 1104 by the one or more second UEs 1106 prior to being received by the first UE 1104. In some cases, the signal measurements received from the one or more second UEs 1106 are calibrated for the first UE 1104 by the first UE 1104 prior to being inputted into the first prediction model for the first UE 1104.

In some cases, in accordance with FIG. 9, obtaining the signal measurements for the one or more signals at 1112 may include the first UE 1104 receiving the signal measurements for the one or more signals from the one or more second UEs 1106, as shown at 1114. In some cases, the signal measurements for the one or more signals received from the one or more second UEs 1106 are performed by the one or more second UEs 1106 the one or more second UEs 1106. In such cases, generating the prediction data comprises at 1118 may include the first UE 1104 generating the prediction data for the one or more second UEs 1106 by inputting the signal measurements received from the one or more second UEs 1106 into the second prediction model for the one or more second UEs 1106. Further, in some cases, obtaining the signal measurements for the one or more signals at 1112 may further include the first UE 1104 performing the signal measurements for the one or more signals for the one or more second UEs 1106, as shown at 1114. Accordingly, in some cases, generating the prediction data for the one or more second UEs 1106 may further include the first UE 1104 generating the prediction data for the one or more second UEs 1106 by inputting the signal measurements performed by the first UE 1104 for the one or more second UEs 1106 into the second prediction model for the one or more second UEs 1106 with the signal measurements for the one or more signals performed by and received from the one or more second UEs 1106.

In some cases, in accordance with the operations described above with respect to UE1 in FIG. 10, the signal measurements comprise signal measurements for the first UE 1104 and signal measurements for at least the one or more second UEs 1106. In some cases, obtaining the signal measurements for the one or more signals at 1112 may include performing the signal measurements for the first UE 1104, as shown at 1114. Additionally, in some cases, obtaining the signal measurements for the one or more signals at 1112 may further include one of one of receiving, from at least the second UE, the signal measurements for at least the second UE (e.g., at 1116) or performing the signal measurements for at least the second UE (e.g., at 1114).

In some cases, the first UE 1104 may generate aggregated signal measurements by aggregating the signal measurements for the first UE with the signal measurements for the one or more second UEs 1106. In such cases, the first UE 1104 may generate the prediction data at 1118 by inputting the aggregated signal measurements into the first prediction model. In such cases, the prediction data generated by inputting the aggregated signal measurements into the first prediction model may include intermediate prediction data. In some cases, transmitting the report at 1120 may include the first UE 1104 transmitting the intermediate prediction data to the one or more second UEs 1106 to be further input into the second prediction model by the one or more second UEs 1106.

In some cases, in accordance with the operations described above with respect to UE4 in FIG. 10, obtaining the signal measurements for the one or more signals at 1112 may include the first UE 1104 performing the signal measurements for the one or more signals for the first UE 1104. Additionally, in some cases, the first UE 1104 may transmit the signal measurements performed by the first UE 1104 to the one or more second UEs 1106. Thereafter, based on the signal measurements performed by the first UE 1104 that are transmitted to the one or more second UEs 1106, the first UE 1104 may receive intermediate prediction data from the one or more second UEs 1106. In some cases the intermediate prediction data includes prediction data generated by the one or more second UEs 1106 based on the second prediction model and aggregated signal measurements associated with at least the first UE 1104 and the one or more second UEs 1106. In some cases, the aggregated signal measurements comprise the signal measurements performed by the first UE 1104 and transmitted to the one or more second UEs 1106 and signal measurements performed by the one or more second UEs 1106. In some cases, the first UE 1104 may then generate final prediction data by inputting the intermediate prediction data received from the one or more second UEs 1106 into the first prediction model. In some cases, the final prediction data includes at least first prediction data for the first UE 1104 and second prediction data for the one or more second UEs 1106.

As discussed above, in some cases, the first UE 1104 may be configured to perform performance monitoring associated with the prediction data. For example, in some cases, the prediction data generated by the first UE 1104 may be generate at a first period of time. In some cases, the prediction data comprises a predicted signal measurement for a signal for a second period of time occurring after the first period of time. In some cases, the first UE 1104 may additionally perform, during the second period of time, an actual signal measurement for the signal corresponding to the predicted signal measurement. Thereafter, in some cases, the first UE 1104 may determine a performance metric associated with the prediction data. In some cases, performance metric may be based on a difference between the predicted signal measurement for the signal and the actual signal measurement for the signal. In some cases, the first UE 1104 may transmit, to the network entity 1102, a performance report indicating the performance metric when one or more conditions are satisfied. In some cases, the one or more conditions comprise the performance metric being greater than or equal to an error threshold.

In some cases, the first UE 1104 may receive, from the network entity 1102, one or more criteria for determining the performance metric, wherein the one or more criteria comprise at least one of a measurement correlation criterion associated with the signal measurements associated with the group of UEs, a geographical correlation criterion associated with UEs in the group of UEs, or a channel quality or signal strength criterion associated with the signal measurements associated with the group of UEs.

In some cases, the first UE 1104 may receive, from the network entity 1102 based on the performance report, an indication to stop the cooperative-based operation and to fall back to normal operation.

### Example Operations

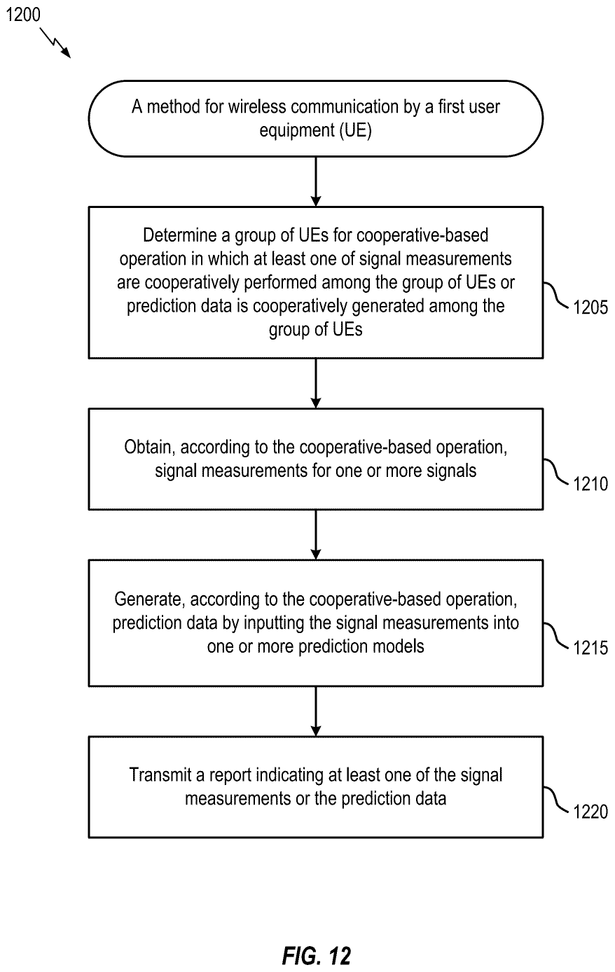

FIG. 12 shows an example of a method 1200 of wireless communication by a first user equipment (UE), such as a UE 104 of FIGS. 1 and 3.

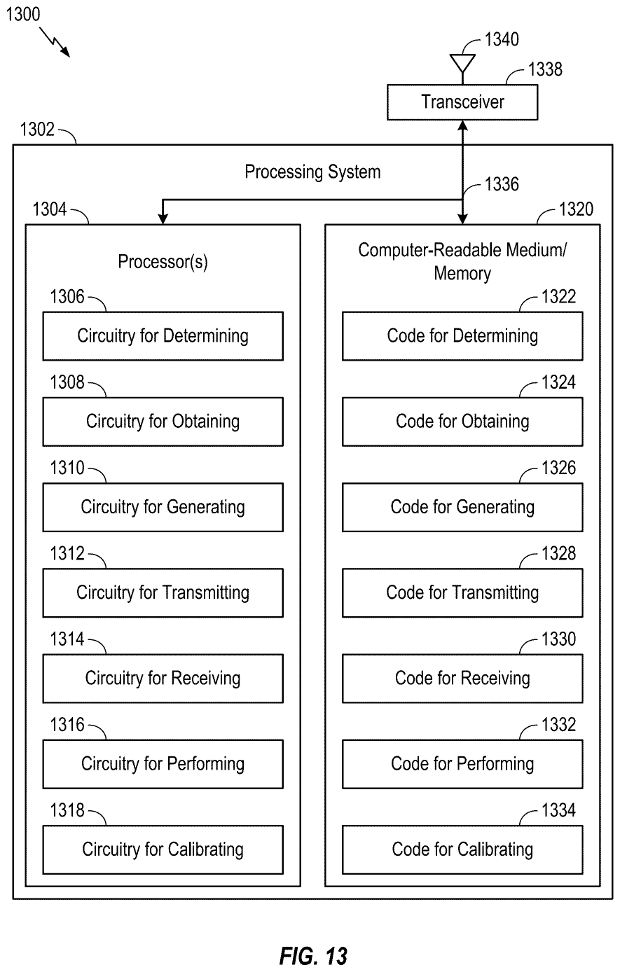

Method 1200 begins at step 1205 with determining a group of UEs for cooperative-based operation in which at least one of signal measurements are cooperatively performed among the group of UEs or prediction data is cooperatively generated among the group of UEs. In some cases, the operations of this step refer to, or may be performed by, circuitry for determining and/or code for determining as described with reference to FIG. 13.

Method 1200 then proceeds to step 1210 with obtaining, according to the cooperative-based operation, signal measurements for one or more signals. In some cases, the operations of this step refer to, or may be performed by, circuitry for obtaining and/or code for obtaining as described with reference to FIG. 13.

Method 1200 then proceeds to step 1215 with generating, according to the cooperative-based operation, prediction data by inputting the signal measurements into one or more prediction models. In some cases, the operations of this step refer to, or may be performed by, circuitry for generating and/or code for generating as described with reference to FIG. 13.

Method 1200 then proceeds to step 1220 with transmitting a report indicating at least one of the signal measurements or the prediction data. In some cases, the operations of this step refer to, or may be performed by, circuitry for transmitting and/or code for transmitting as described with reference to FIG. 13.

In some aspects, the cooperative-based operation includes one or more cooperative modes, including at least one of: a measurement delegation mode in which the UE operates as a delegate UE to perform signal measurements on behalf of one or more UEs of the group of UEs; a measurement collaboration mode in which each UE of the group of UEs performs a different subset of signal measurements and the different subsets of signal measurements are aggregated together by one UE of the group of UEs; a first prediction mode in which the UE is configured to generate the prediction data based on the signal measurements resulting from the measurement delegation mode or the measurement collaboration mode; a second prediction mode in which the UE is configured to generate the prediction data for at least a second UE in the group of UEs; or a third prediction mode in which the group of UEs, including the UE, are configured to generate the prediction data in a joint manner.

In some aspects, the method 1200 further includes transmitting UE capability information indicating which cooperative modes of the one or more cooperative modes that the first UE supports. In some cases, the operations of this step refer to, or may be performed by, circuitry for transmitting and/or code for transmitting as described with reference to FIG. 13.

In some aspects, the UE capability information statically indicates which cooperative modes of the one or more cooperative modes that the first UE supports; or the UE capability information dynamically indicates which cooperative modes of the one or more cooperative modes that the first UE supports.

In some aspects, the UE capability information is transmitted to a network entity.

In some aspects, the method 1200 further includes transmitting, to a network entity, a message requesting the cooperative-based operation according to at least one cooperative mode of the one or more cooperative modes. In some cases, the operations of this step refer to, or may be performed by, circuitry for transmitting and/or code for transmitting as described with reference to FIG. 13.

In some aspects, the method 1200 further includes receiving, from the network entity based on the request for the cooperative-based operation, configuration information configuring the at least one cooperative mode. In some cases, the operations of this step refer to, or may be performed by, circuitry for receiving and/or code for receiving as described with reference to FIG. 13.

In some aspects, the configuration information indicates: a cooperative operation mode, of the one or more cooperative modes indicated in the UE capability information, for the UE to operate in; and a set of measurement resources for performing the signal measurements.

In some aspects, the set of measurement resources include at least one of: one or more frequencies on which to perform the signal measurements; one or more cells for which to perform the signal measurements; one or more reference signal types for which to perform the signal measurements; or a periodic time window for performing the signal measurements.

In some aspects, the method 1200 further includes generating, based on the configuration information received from the network entity, group configuration information indicating a subset of measurement resources for configuring the cooperative-based operation for the group of UEs. In some cases, the operations of this step refer to, or may be performed by, circuitry for generating and/or code for generating as described with reference to FIG. 13.

In some aspects, the method 1200 further includes transmitting, to the group of UEs, the group configuration information indicating the subset of measurement resources for configuring the cooperative-based operation. In some cases, the operations of this step refer to, or may be performed by, circuitry for transmitting and/or code for transmitting as described with reference to FIG. 13.

In some aspects, the UE capability information is transmitted to the group of UEs.

In some aspects, the method 1200 further includes receiving, from at least a second UE in the group of UEs based on the UE capability information, a message requesting the cooperative-based operation according to at least one cooperative mode of the one or more cooperative modes. In some cases, the operations of this step refer to, or may be performed by, circuitry for receiving and/or code for receiving as described with reference to FIG. 13.

In some aspects, the method 1200 further includes transmitting a response message acknowledging the requested at least one cooperative mode. In some cases, the operations of this step refer to, or may be performed by, circuitry for transmitting and/or code for transmitting as described with reference to FIG. 13.

In some aspects, the method 1200 further includes determining group configuration information indicating measurement resources for configuring the at least one cooperative mode for the group of UEs. In some cases, the operations of this step refer to, or may be performed by, circuitry for determining and/or code for determining as described with reference to FIG. 13.

In some aspects, the method 1200 further includes transmitting, to the group of UEs, the group configuration information indicating the measurement resources for configuring the at least one cooperative mode. In some cases, the operations of this step refer to, or may be performed by, circuitry for transmitting and/or code for transmitting as described with reference to FIG. 13.

In some aspects, the group configuration information indicating measurement resources for configuring the at least one cooperative mode for the group of UEs is determined without involvement from a network entity.

In some aspects, the method 1200 further includes receiving, from a network entity or another UE in the group of UEs, a message indicating that the first UE has been selected as a delegate UE for the cooperative-based operation. In some cases, the operations of this step refer to, or may be performed by, circuitry for receiving and/or code for receiving as described with reference to FIG. 13.

In some aspects, based on the first UE being selected as the delegate UE, generating prediction data comprises generating the prediction data for at least one UE in the group of UEs; and transmitting the report comprises transmitting the report to the at least one UE including the prediction data generated by the first UE for the at least one UE.

In some aspects, based on the first UE being selected as the delegate UE, obtaining the signal measurements for the one or more signals comprises performing the signal measurements for a second UE in the group of UEs.

In some aspects, the method 1200 further includes calibrating the signal measurements performed at the first UE for the second UE. In some cases, the operations of this step refer to, or may be performed by, circuitry for calibrating and/or code for calibrating as described with reference to FIG. 13.

In some aspects, calibrating the signal measurements performed at the first UE adjusts the signal measurements performed at the first UE to be representative of signal measurements that would have been performed by the second UE.

In some aspects, the method 1200 further includes receiving a set of calibration parameters from the second UE, wherein calibrating the signal measurements performed for the second UE is based on a set of calibration parameters received from the second UE. In some cases, the operations of this step refer to, or may be performed by, circuitry for receiving and/or code for receiving as described with reference to FIG. 13.

In some aspects, the set of calibration parameters include at least one of: an indication of a reference signal type of signal measurements performed by the second UE corresponding to a historic period of time; signal measurements performed by the second UE corresponding to a historic period of time; an indication of a reference signal type corresponding to prediction data generated by the second UE corresponding to a historic period of time; prediction data generated by the second UE corresponding to a historic period of time; an indication of a location of the second UE; an indication of an altitude of the second UE; an indication of a direction in which the second UE is facing; an indication of a blockage between the second UE and a network entity; or an indication of a signal condition associated with the second UE including one of a line-of-sight (LoS) condition or non-line-of-sight (NLoS) condition.

In some aspects, the signal measurements for one or more signals are performed at a second UE; and obtaining signal measurements for the one or more signals comprises receiving the signal measurements for the one or more signals from the second UE.

In some aspects, the method 1200 further includes calibrating, based on a set of calibration parameters, the signal measurements performed at the second UE for the first UE, wherein calibrating the signal measurements performed at the second UE adjusts the signal measurements performed at the second UE to be representative of signal measurements that would have been performed by the first UE. In some cases, the operations of this step refer to, or may be performed by, circuitry for calibrating and/or code for calibrating as described with reference to FIG. 13.

In some aspects, the method 1200 further includes transmitting, to the second UE, a set of calibration parameters for calibrating the signal measurements performed at the second UE for the first UE, wherein the signal measurements received from the second UE are calibrated at the second UE based on the set of calibration parameters transmitted to the second UE. In some cases, the operations of this step refer to, or may be performed by, circuitry for transmitting and/or code for transmitting as described with reference to FIG. 13.

In some aspects, the method 1200 further includes receiving the one or more prediction models in a broadcast or multicast message from at least one UE in the group of UEs. In some cases, the operations of this step refer to, or may be performed by, circuitry for receiving and/or code for receiving as described with reference to FIG. 13.

In some aspects, at least one of: the one or more prediction models are preconfigured in memory of the first UE by a manufacturer or distributor of the first UE; or the one or more prediction models are received from a network entity; and the method further comprises transmitting the one or more prediction models in a broadcast or multicast message to at least one UE in the group of UEs.

In some aspects, the method 1200 further includes transmitting, to a network entity, a request for the network entity to transmit the one or more prediction models to the group of UEs. In some cases, the operations of this step refer to, or may be performed by, circuitry for transmitting and/or code for transmitting as described with reference to FIG. 13.

In some aspects, the method 1200 further includes receiving the one or more prediction models from the network entity based on the request. In some cases, the operations of this step refer to, or may be performed by, circuitry for receiving and/or code for receiving as described with reference to FIG. 13.

In some aspects, the one or more prediction models comprise at least a first prediction model for the first UE and a second prediction model for a second UE.

In some aspects, the first prediction model from the first UE is the same as the second prediction model for the second UE.

In some aspects, the first prediction model for the first UE is different from the second prediction model for the second UE.

In some aspects, obtaining the signal measurements for the one or more signals comprises performing the signal measurements for the one or more signals; and generating the prediction data comprises generating the prediction data by inputting the signal measurements into the first prediction model for the first UE.

In some aspects, obtaining the signal measurements for the one or more signals further comprises receiving the signal measurements for the one or more signals from the second UE, wherein the signal measurements for the one or more signals received from the second UE are performed by the second UE for the first UE; and generating the prediction data further comprises generating the prediction data by inputting the signal measurements received from the second UE into the first prediction model for the first UE with the signal measurements performed by the first UE.

In some aspects, one of: the signal measurements received from the second UE are calibrated for the first UE by the second UE prior to being received by the first UE; or the signal measurements received from the second UE are calibrated for the first UE by the first UE prior to being inputted into the first prediction model for the first UE.

In some aspects, obtaining the signal measurements for the one or more signals comprises receiving the signal measurements for the one or more signals from the second UE; and generating the prediction data comprises generating the prediction data by inputting the signal measurements received from the second UE into the first prediction model for the first UE.

In some aspects, one of: the signal measurements received from the second UE are calibrated for the first UE by the second UE prior to being received by the first UE; or the signal measurements received from the second UE are calibrated for the first UE by the first UE prior to being inputted into the first prediction model for the first UE.

In some aspects, obtaining the signal measurements for the one or more signals comprises receiving the signal measurements for the one or more signals from the second UE, wherein the signal measurements for the one or more signals received from the second UE are performed by the second UE for the second UE; and generating the prediction data comprises generating the prediction data for the second UE by inputting the signal measurements received from the second UE into the second prediction model for the second UE.

In some aspects, obtaining the signal measurements for the one or more signals further comprises performing the signal measurements for the one or more signals for the second UE; and generating the prediction data for the second UE further comprises generating the prediction data for the second UE by inputting the signal measurements performed by the first UE for the second UE into the second prediction model for the second UE with the signal measurements for the one or more signals received from the second UE.

In some aspects, the signal measurements comprise signal measurements for the first UE and signal measurements for at least the second UE.

In some aspects, obtaining the signal measurements for the one or more signals comprises: performing the signal measurements for the first UE; and one of: receiving, from at least the second UE, the signal measurements for at least the second UE; or performing the signal measurements for at least the second UE.

In some aspects, the method 1200 further includes generating aggregated signal measurements by aggregating the signal measurements for the first UE with the signal measurements for at least the second UE. In some cases, the operations of this step refer to, or may be performed by, circuitry for generating and/or code for generating as described with reference to FIG. 13.

In some aspects, generating the prediction data by inputting the signal measurements into the one or more prediction models comprises inputting the aggregated signal measurements into the first prediction model.

In some aspects, the prediction data generated by inputting the aggregated signal measurements into the first prediction model comprises intermediate prediction data.

In some aspects, transmitting the report comprises transmitting the intermediate prediction data to at least the second UE to be further input into the second prediction model by at least the second UE.

In some aspects, obtaining the signal measurements for the one or more signals comprises performing the signal measurements for the one or more signals; and the method further comprises transmitting the signal measurements performed by the first UE to the second UE.

In some aspects, the method 1200 further includes receiving intermediate prediction data from the second UE. In some cases, the operations of this step refer to, or may be performed by, circuitry for receiving and/or code for receiving as described with reference to FIG. 13.

In some aspects, the intermediate prediction data includes prediction data generated by the second UE based on the second prediction model and aggregated signal measurements associated with at least the first UE and the second UE; and the aggregated signal measurements comprise: the signal measurements performed by the first UE and transmitted to the second UE; and signal measurements performed by the second UE.

In some aspects, the method 1200 further includes generating final prediction data by inputting the intermediate prediction data received from the second UE into the first prediction model. In some cases, the operations of this step refer to, or may be performed by, circuitry for generating and/or code for generating as described with reference to FIG. 13.

In some aspects, the final prediction data includes at least first prediction data for the first UE and second prediction data for the second UE.

In some aspects, the prediction data is generated at a first period of time; and the prediction data comprises a predicted signal measurement for a signal for a second period of time occurring after the first period of time.

In some aspects, the method 1200 further includes performing, during the second period of time, an actual signal measurement for the signal corresponding to the predicted signal measurement. In some cases, the operations of this step refer to, or may be performed by, circuitry for performing and/or code for performing as described with reference to FIG. 13.

In some aspects, the method 1200 further includes determining a performance metric associated with the prediction data. In some cases, the operations of this step refer to, or may be performed by, circuitry for determining and/or code for determining as described with reference to FIG. 13.

In some aspects, the performance metric is based on a difference between the predicted signal measurement for the signal and the actual signal measurement for the signal.

In some aspects, the method 1200 further includes transmitting, to a network entity, a performance report indicating the performance metric when one or more conditions are satisfied. In some cases, the operations of this step refer to, or may be performed by, circuitry for transmitting and/or code for transmitting as described with reference to FIG. 13.

In some aspects, the one or more conditions comprise the performance metric being greater than or equal to an error threshold.

In some aspects, the method 1200 further includes receiving, from the network entity, one or more criteria for determining the performance metric, wherein the one or more criteria comprise at least one of: a measurement correlation criterion associated with the signal measurements associated with the group of UEs a geographical correlation criterion associated with UEs in the group of UEs a channel quality or signal strength criterion associated with the signal measurements associated with the group of UEs. In some cases, the operations of this step refer to, or may be performed by, circuitry for receiving and/or code for receiving as described with reference to FIG. 13.

In some aspects, the method 1200 further includes receiving, from the network entity based on the performance report, an indication to stop the cooperative-based operation and to fall back to normal operation. In some cases, the operations of this step refer to, or may be performed by, circuitry for receiving and/or code for receiving as described with reference to FIG. 13.

In some aspects, the method 1200 further includes transmitting a broadcast message requesting for one or more UEs to join the group of UEs. In some cases, the operations of this step refer to, or may be performed by, circuitry for transmitting and/or code for transmitting as described with reference to FIG. 13.

In some aspects, the method 1200 further includes receiving, from the one or more UEs, one or more response messages accepting the request to join the group of UEs. In some cases, the operations of this step refer to, or may be performed by, circuitry for receiving and/or code for receiving as described with reference to FIG. 13.

In some aspects, determining the group of UEs is based on the one or more response messages; and the group of UEs includes the one or more UEs for which the one or more response messages have been received.

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communications Device(s)

FIG. 13 depicts aspects of an example communications device 1300. In some aspects, communications device 1300 is a user equipment, such as UE 104 described above with respect to FIGS. 1 and 3.

The communications device 1300 includes a processing system 1302 coupled to the transceiver 1338 (e.g., a transmitter and/or a receiver). The transceiver 1338 is configured to transmit and receive signals for the communications device 1300 via the antenna 1340, such as the various signals as described herein. The processing system 1302 may be configured to perform processing functions for the communications device 1300, including processing signals received and/or to be transmitted by the communications device 1300.

The processing system 1302 includes one or more processors 1304. In various aspects, the one or more processors 1304 may be representative of one or more of receive processor 358, transmit processor 364, TX MIMO processor 366, and/or controller/processor 380, as described with respect to FIG. 3. The one or more processors 1304 are coupled to a computer-readable medium/memory 1320 via a bus 1336. In certain aspects, the computer-readable medium/memory 1320 is configured to store instructions (e.g., computer-executable code) that when executed by the one or more processors 1304, cause the one or more processors 1304 to perform the method 1200 described with respect to FIG. 12, or any aspect related to it. Note that reference to a processor performing a function of communications device 1300 may include one or more processors 1304 performing that function of communications device 1300.

In the depicted example, computer-readable medium/memory 1320 stores code (e.g., executable instructions), such as code for determining 1322, code for obtaining 1324, code for generating 1326, code for transmitting 1328, code for receiving 1330, code for performing 1332, and code for calibrating 1334. Processing of the code for determining 1322, code for obtaining 1324, code for generating 1326, code for transmitting 1328, code for receiving 1330, code for performing 1332, and code for calibrating 1334 may cause the communications device 1300 to perform the method 1200 described with respect to FIG. 12, or any aspect related to it.

The one or more processors 1304 include circuitry configured to implement (e.g., execute) the code stored in the computer-readable medium/memory 1320, including circuitry such as circuitry for determining 1306, circuitry for obtaining 1308, circuitry for generating 1310, circuitry for transmitting 1312, circuitry for receiving 1314, circuitry for performing 1316, and circuitry for calibrating 1318. Processing with circuitry for determining 1306, circuitry for obtaining 1308, circuitry for generating 1310, circuitry for transmitting 1312, circuitry for receiving 1314, circuitry for performing 1316, and circuitry for calibrating 1318 may cause the communications device 1300 to perform the method 1200 described with respect to FIG. 12, or any aspect related to it.

Various components of the communications device 1300 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1338 and the antenna 1340 of the communications device 1300 in FIG. 13. Means for receiving or obtaining may include transceivers 354 and/or antenna(s) 352 of the UE 104 illustrated in FIG. 3 and/or the transceiver 1338 and the antenna 1340 of the communications device 1300 in FIG. 13.

### Example Clauses

Implementation examples are described in the following numbered clauses:

Clause 1: A method for wireless communication by a first user equipment (UE), comprising: determining a group of UEs for cooperative-based operation in which at least one of signal measurements are cooperatively performed among the group of UEs or prediction data is cooperatively generated among the group of UEs; obtaining, according to the cooperative-based operation, signal measurements for one or more signals; generating, according to the cooperative-based operation, prediction data by inputting the signal measurements into one or more prediction models; and transmitting a report indicating at least one of the signal measurements or the prediction data.

Clause 2: The method of Clause 1, wherein the cooperative-based operation includes one or more cooperative modes, including at least one of: a measurement delegation mode in which the UE operates as a delegate UE to perform signal measurements on behalf of one or more UEs of the group of UEs; a measurement collaboration mode in which each UE of the group of UEs performs a different subset of signal measurements and the different subsets of signal measurements are aggregated together by one UE of the group of UEs; a first prediction mode in which the UE is configured to generate the prediction data based on the signal measurements resulting from the measurement delegation mode or the measurement collaboration mode; a second prediction mode in which the UE is configured to generate the prediction data for at least a second UE in the group of UEs; or a third prediction mode in which the group of UEs, including the UE, are configured to generate the prediction data in a joint manner.

Clause 3: The method of Clause 2, further comprising transmitting UE capability information indicating which cooperative modes of the one or more cooperative modes that the first UE supports.

Clause 4: The method of Clause 3, wherein: the UE capability information statically indicates which cooperative modes of the one or more cooperative modes that the first UE supports; or the UE capability information dynamically indicates which cooperative modes of the one or more cooperative modes that the first UE supports.

Clause 5: The method of Clause 3, wherein the UE capability information is transmitted to a network entity.

Clause 6: The method of Clause 3, further comprising: transmitting, to a network entity, a message requesting the cooperative-based operation according to at least one cooperative mode of the one or more cooperative modes; and receiving, from the network entity based on the request for the cooperative-based operation, configuration information configuring the at least one cooperative mode.

Clause 7: The method of Clause 6, wherein the configuration information indicates: a cooperative operation mode, of the one or more cooperative modes indicated in the UE capability information, for the UE to operate in; and a set of measurement resources for performing the signal measurements.

Clause 8: The method of Clause 7, wherein the set of measurement resources include at least one of: one or more frequencies on which to perform the signal measurements; one or more cells for which to perform the signal measurements; one or more reference signal types for which to perform the signal measurements; or a periodic time window for performing the signal measurements.

Clause 9: The method of Clause 8, further comprising: generating, based on the configuration information received from the network entity, group configuration information indicating a subset of measurement resources for configuring the cooperative-based operation for the group of UEs; and transmitting, to the group of UEs, the group configuration information indicating the subset of measurement resources for configuring the cooperative-based operation.

Clause 10: The method of Clause 3, wherein the UE capability information is transmitted to the group of UEs.

Clause 11: The method of Clause 10, further comprising: receiving, from at least a second UE in the group of UEs based on the UE capability information, a message requesting the cooperative-based operation according to at least one cooperative mode of the one or more cooperative modes; and transmitting a response message acknowledging the requested at least one cooperative mode.

Clause 12: The method of Clause 11, further comprising: determining group configuration information indicating measurement resources for configuring the at least one cooperative mode for the group of UEs; and transmitting, to the group of UEs, the group configuration information indicating the measurement resources for configuring the at least one cooperative mode.

Clause 13: The method of Clause 12, wherein the group configuration information indicating measurement resources for configuring the at least one cooperative mode for the group of UEs is determined without involvement from a network entity.

Clause 14: The method of any one of Clauses 1-13, further comprising receiving, from a network entity or another UE in the group of UEs, a message indicating that the first UE has been selected as a delegate UE for the cooperative-based operation.

Clause 15: The method of Clause 14, wherein: based on the first UE being selected as the delegate UE, generating prediction data comprises generating the prediction data for at least one UE in the group of UEs; and transmitting the report comprises transmitting the report to the at least one UE including the prediction data generated by the first UE for the at least one UE.

Clause 16: The method of Clause 14, wherein, based on the first UE being selected as the delegate UE, obtaining the signal measurements for the one or more signals comprises performing the signal measurements for a second UE in the group of UEs.

Clause 17: The method of Clause 16, further comprising calibrating the signal measurements performed at the first UE for the second UE.

Clause 18: The method of Clause 17, wherein calibrating the signal measurements performed at the first UE adjusts the signal measurements performed at the first UE to be representative of signal measurements that would have been performed by the second UE.

Clause 19: The method of Clause 18, further comprising receiving a set of calibration parameters from the second UE, wherein calibrating the signal measurements performed for the second UE is based on a set of calibration parameters received from the second UE.

Clause 20: The method of Clause 19, wherein the set of calibration parameters include at least one of: an indication of a reference signal type of signal measurements performed by the second UE corresponding to a historic period of time; signal measurements performed by the second UE corresponding to a historic period of time; an indication of a reference signal type corresponding to prediction data generated by the second UE corresponding to a historic period of time; prediction data generated by the second UE corresponding to a historic period of time; an indication of a location of the second UE; an indication of an altitude of the second UE; an indication of a direction in which the second UE is facing; an indication of a blockage between the second UE and a network entity; or an indication of a signal condition associated with the second UE including one of a line-of-sight (LoS) condition or non-line-of-sight (NLoS) condition.

Clause 21: The method of any one of Clauses 1-20, wherein: the signal measurements for one or more signals are performed at a second UE; and obtaining signal measurements for the one or more signals comprises receiving the signal measurements for the one or more signals from the second UE.

Clause 22: The method of Clause 21, further comprising calibrating, based on a set of calibration parameters, the signal measurements performed at the second UE for the first UE, wherein calibrating the signal measurements performed at the second UE adjusts the signal measurements performed at the second UE to be representative of signal measurements that would have been performed by the first UE.

Clause 23: The method of Clause 21, further comprising transmitting, to the second UE, a set of calibration parameters for calibrating the signal measurements performed at the second UE for the first UE, wherein the signal measurements received from the second UE are calibrated at the second UE based on the set of calibration parameters transmitted to the second UE.

Clause 24: The method of any one of Clauses 1-23, further comprising receiving the one or more prediction models in a broadcast or multicast message from at least one UE in the group of UEs.

Clause 25: The method of any one of Clauses 1-24, wherein: at least one of: the one or more prediction models are preconfigured in memory of the first UE by a manufacturer or distributor of the first UE; or the one or more prediction models are received from a network entity; and the method further comprises transmitting the one or more prediction models in a broadcast or multicast message to at least one UE in the group of UEs.

Clause 26: The method of any one of Clauses 1-25, further comprising: transmitting, to a network entity, a request for the network entity to transmit the one or more prediction models to the group of UEs; and receiving the one or more prediction models from the network entity based on the request.

Clause 27: The method of any one of Clauses 1-26, wherein the one or more prediction models comprise at least a first prediction model for the first UE and a second prediction model for a second UE.

Clause 28: The method of Clause 27, wherein the first prediction model from the first UE is the same as the second prediction model for the second UE.

Clause 29: The method of Clause 27, wherein the first prediction model for the first UE is different from the second prediction model for the second UE.

Clause 30: The method of Clause 27, wherein: obtaining the signal measurements for the one or more signals comprises performing the signal measurements for the one or more signals; and generating the prediction data comprises generating the prediction data by inputting the signal measurements into the first prediction model for the first UE.

Clause 31: The method of Clause 30, wherein: obtaining the signal measurements for the one or more signals further comprises receiving the signal measurements for the one or more signals from the second UE, wherein the signal measurements for the one or more signals received from the second UE are performed by the second UE for the first UE; and generating the prediction data further comprises generating the prediction data by inputting the signal measurements received from the second UE into the first prediction model for the first UE with the signal measurements performed by the first UE.

Clause 32: The method of Clause 31, wherein one of: the signal measurements received from the second UE are calibrated for the first UE by the second UE prior to being received by the first UE; or the signal measurements received from the second UE are calibrated for the first UE by the first UE prior to being inputted into the first prediction model for the first UE.

Clause 33: The method of Clause 27, wherein: obtaining the signal measurements for the one or more signals comprises receiving the signal measurements for the one or more signals from the second UE; and generating the prediction data comprises generating the prediction data by inputting the signal measurements received from the second UE into the first prediction model for the first UE.

Clause 34: The method of Clause 33, wherein one of: the signal measurements received from the second UE are calibrated for the first UE by the second UE prior to being received by the first UE; or the signal measurements received from the second UE are calibrated for the first UE by the first UE prior to being inputted into the first prediction model for the first UE.

Clause 35: The method of Clause 27, wherein: obtaining the signal measurements for the one or more signals comprises receiving the signal measurements for the one or more signals from the second UE, wherein the signal measurements for the one or more signals received from the second UE are performed by the second UE for the second UE; and generating the prediction data comprises generating the prediction data for the second UE by inputting the signal measurements received from the second UE into the second prediction model for the second UE.

Clause 36: The method of Clause 35, wherein: obtaining the signal measurements for the one or more signals further comprises performing the signal measurements for the one or more signals for the second UE; and generating the prediction data for the second UE further comprises generating the prediction data for the second UE by inputting the signal measurements performed by the first UE for the second UE into the second prediction model for the second UE with the signal measurements for the one or more signals received from the second UE.

Clause 37: The method of Clause 27, wherein the signal measurements comprise signal measurements for the first UE and signal measurements for at least the second UE.

Clause 38: The method of Clause 37, wherein obtaining the signal measurements for the one or more signals comprises: performing the signal measurements for the first UE; and one of: receiving, from at least the second UE, the signal measurements for at least the second UE; or performing the signal measurements for at least the second UE.

Clause 39: The method of Clause 38, further comprising generating aggregated signal measurements by aggregating the signal measurements for the first UE with the signal measurements for at least the second UE.

Clause 40: The method of Clause 39, wherein generating the prediction data by inputting the signal measurements into the one or more prediction models comprises inputting the aggregated signal measurements into the first prediction model.

Clause 41: The method of Clause 40, wherein the prediction data generated by inputting the aggregated signal measurements into the first prediction model comprises intermediate prediction data.

Clause 42: The method of Clause 41, wherein transmitting the report comprises transmitting the intermediate prediction data to at least the second UE to be further input into the second prediction model by at least the second UE.

Clause 43: The method of Clause 27, wherein: obtaining the signal measurements for the one or more signals comprises performing the signal measurements for the one or more signals; and the method further comprises transmitting the signal measurements performed by the first UE to the second UE.

Clause 44: The method of Clause 43, further comprising receiving intermediate prediction data from the second UE.

Clause 45: The method of Clause 44, wherein: the intermediate prediction data includes prediction data generated by the second UE based on the second prediction model and aggregated signal measurements associated with at least the first UE and the second UE; and the aggregated signal measurements comprise: the signal measurements performed by the first UE and transmitted to the second UE; and signal measurements performed by the second UE.

Clause 46: The method of Clause 44, further comprising generating final prediction data by inputting the intermediate prediction data received from the second UE into the first prediction model.

Clause 47: The method of Clause 46, wherein the final prediction data includes at least first prediction data for the first UE and second prediction data for the second UE.

Clause 48: The method of any one of Clauses 1-47, wherein: the prediction data is generated at a first period of time; and the prediction data comprises a predicted signal measurement for a signal for a second period of time occurring after the first period of time.

Clause 49: The method of Clause 48, further comprising performing, during the second period of time, an actual signal measurement for the signal corresponding to the predicted signal measurement.

Clause 50: The method of Clause 49, further comprising determining a performance metric associated with the prediction data.

Clause 51: The method of Clause 50, wherein the performance metric is based on a difference between the predicted signal measurement for the signal and the actual signal measurement for the signal.

Clause 52: The method of Clause 50, further comprising transmitting, to a network entity, a performance report indicating the performance metric when one or more conditions are satisfied.

Clause 53: The method of Clause 52, wherein the one or more conditions comprise the performance metric being greater than or equal to an error threshold.

Clause 54: The method of Clause 52, further comprising receiving, from the network entity, one or more criteria for determining the performance metric, wherein the one or more criteria comprise at least one of: a measurement correlation criterion associated with the signal measurements associated with the group of UEs a geographical correlation criterion associated with UEs in the group of UEs a channel quality or signal strength criterion associated with the signal measurements associated with the group of UEs.

Clause 55: The method of Clause 52, further comprising receiving, from the network entity based on the performance report, an indication to stop the cooperative-based operation and to fall back to normal operation.

Clause 56: The method of any one of Clauses 1-55, further comprising: transmitting a broadcast message requesting for one or more UEs to join the group of UEs; and receiving, from the one or more UEs, one or more response messages accepting the request to join the group of UEs.

Clause 57: The method of Clause 56, wherein: determining the group of UEs is based on the one or more response messages; and the group of UEs includes the one or more UEs for which the one or more response messages have been received.

Clause 58: An apparatus, comprising: at least one memory comprising executable instructions; and at least one processor configured to execute the executable instructions and cause the apparatus to perform a method in accordance with any combination of Clauses 1-57.

Clause 59: An apparatus, comprising means for performing a method in accordance with any combination of Clauses 1-57.

Clause 60: A non-transitory computer-readable medium comprising executable instructions that, when executed by at least one processor of an apparatus, cause the apparatus to perform a method in accordance with any combination of Clauses 1-57.

Clause 61: A computer program product embodied on a computer-readable storage medium comprising code for performing a method in accordance with any combination of Clauses 1-57.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first user equipment (UE), comprising:
one or more processors configured to execute instructions stored on one or more memories to cause the first UE to:
determine a group of UEs for cooperative-based operation in which at least one of signal measurements are cooperatively performed among the group of UEs or prediction data is cooperatively generated among the group of UEs;
obtain, according to the cooperative-based operation, signal measurements for one or more signals;
generate, according to the cooperative-based operation, prediction data by inputting the signal measurements into one or more prediction models; and
transmit a report indicating at least one of the signal measurements or the prediction data.

2. The first UE of claim 1, wherein the cooperative-based operation includes one or more cooperative modes, including at least one of:
a measurement delegation mode in which the UE operates as a delegate UE to perform signal measurements on behalf of one or more UEs of the group of UEs;
a measurement collaboration mode in which each UE of the group of UEs performs a different subset of signal measurements and the different subsets of signal measurements are aggregated together by one UE of the group of UEs;
a first prediction mode in which the UE is configured to generate the prediction data based on the signal measurements resulting from the measurement delegation mode or the measurement collaboration mode;
a second prediction mode in which the UE is configured to generate the prediction data for at least a second UE in the group of UEs; or
a third prediction mode in which the group of UEs, including the UE, are configured to generate the prediction data in a joint manner.

3. The first UE of claim 2, wherein:
the one or more processors are further configured to cause the first UE to transmit UE capability information indicating which cooperative modes of the one or more cooperative modes that the first UE supports; and
one of:
the UE capability information statically indicates which cooperative modes of the one or more cooperative modes that the first UE supports; or
the UE capability information dynamically indicates which cooperative modes of the one or more cooperative modes that the first UE supports.

4. The first UE of claim 3, wherein:
the one or more processors are configured to cause the UE to transmit the UE capability information to a network entity; and
the one or more processors are further configured to cause the first UE to:
transmit, to a network entity, a message requesting the cooperative-based operation according to at least one cooperative mode of the one or more cooperative modes; and
receive, from the network entity based on the request for the cooperative-based operation, configuration information configuring the at least one cooperative mode.

5. The first UE of claim 4, wherein:
the configuration information indicates:
a cooperative operation mode, of the one or more cooperative modes indicated in the UE capability information, for the UE to operate in; and
a set of measurement resources for performing the signal measurements; and
the set of measurement resources include at least one of:
one or more frequencies on which to perform the signal measurements;
one or more cells for which to perform the signal measurements;
one or more reference signal types for which to perform the signal measurements; or
a periodic time window for performing the signal measurements.

6. The first UE of claim 5, wherein the one or more processors are further configured to cause the first UE to:
generate, based on the configuration information received from the network entity, group configuration information indicating a subset of measurement resources for configuring the cooperative-based operation for the group of UEs; and
transmit, to the group of UEs, the group configuration information indicating the subset of measurement resources for configuring the cooperative-based operation.

7. The first UE of claim 3, wherein:
the UE capability information is transmitted to the group of UEs; and
the one or more processors are further configured to cause the first UE to:
receive, from at least a second UE in the group of UEs based on the UE capability information, a message requesting the cooperative-based operation according to at least one cooperative mode of the one or more cooperative modes; and
transmit a response message acknowledging the requested at least one cooperative mode;
determine group configuration information indicating measurement resources for configuring the at least one cooperative mode for the group of UEs; and
transmit, to the group of UEs, the group configuration information indicating the measurement resources for configuring the at least one cooperative mode; and
the group configuration information indicating measurement resources for configuring the at least one cooperative mode for the group of UEs is determined without involvement from a network entity.

8. The first UE of claim 1, wherein:
the one or more processors are further configured to cause the first UE to receive, from a network entity or another UE in the group of UEs, a message indicating that the first UE has been selected as a delegate UE for the cooperative-based operation;
based on the first UE being selected as the delegate UE, in order to obtain the signal measurements for the one or more signals, the one or more processors are configured to cause the first UE to perform the signal measurements for a second UE in the group of UEs;
the one or more processors are further configured to cause the first UE to:
receive a set of calibration parameters from the second UE;
calibrate, based on the set of calibration parameters received from the second UE, the signal measurements performed at the first UE for the second UE; and
calibrating the signal measurements performed at the first UE adjusts the signal measurements performed at the first UE to be representative of signal measurements that would have been performed by the second UE.

9. The first UE of claim 8, wherein the set of calibration parameters include at least one of:
an indication of a reference signal type of signal measurements performed by the second UE corresponding to a historic period of time;
signal measurements performed by the second UE corresponding to a historic period of time;
an indication of a reference signal type corresponding to prediction data generated by the second UE corresponding to a historic period of time;
prediction data generated by the second UE corresponding to a historic period of time;
an indication of a location of the second UE;
an indication of an altitude of the second UE;
an indication of a direction in which the second UE is facing;
an indication of a blockage between the second UE and a network entity; or
an indication of a signal condition associated with the second UE including one of a line-of-sight (LoS) condition or non-line-of-sight (NLoS) condition.

10. The first UE of claim 1, wherein one of:
the one or more processors are further configured to cause the first UE to receive the one or more prediction models in a broadcast or multicast message from at least one UE in the group of UEs; or
the one or more processors are further configured to cause the first UE to:
transmit, to a network entity, a request for the network entity to transmit the one or more prediction models to the group of UEs; and
receive the one or more prediction models from the network entity based on the request.

11. The first UE of claim 1, wherein the one or more prediction models comprise at least a first prediction model for the first UE and a second prediction model for a second UE.

12. The first UE of claim 11, wherein:
in order to obtain the signal measurements for the one or more signals, the one or more processors are configured to cause the first UE to perform the signal measurements for the one or more signals;
in order to generate the prediction data, the one or more processors are configured to cause the first UE to generate the prediction data by inputting the signal measurements into the first prediction model for the first UE;
in order to obtain the signal measurements for the one or more signals, the one or more processors are further configured to cause the first UE to receive the signal measurements for the one or more signals from the second UE;
the signal measurements for the one or more signals received from the second UE are performed by the second UE for the first UE;
in order to generate the prediction data, the one or more processors are further configured to cause the first UE to generate the prediction data by inputting the signal measurements received from the second UE into the first prediction model for the first UE with the signal measurements performed by the first UE; and
one of:
the signal measurements received from the second UE are calibrated for the first UE by the second UE prior to being received by the first UE; or
the signal measurements received from the second UE are calibrated for the first UE by the first UE prior to being inputted into the first prediction model for the first UE.

13. The first UE of claim 11, wherein:
in order to obtain the signal measurements for the one or more signals, the one or more processors are configured to cause the first UE to receive the signal measurements for the one or more signals from the second UE;
in order to generate the prediction data, the one or more processors are configured to cause the first UE to generate the prediction data by inputting the signal measurements received from the second UE into the first prediction model for the first UE; and
one of:
the signal measurements received from the second UE are calibrated for the first UE by the second UE prior to being received by the first UE; or
the signal measurements received from the second UE are calibrated for the first UE by the first UE prior to being inputted into the first prediction model for the first UE.

14. The first UE of claim 11, wherein:
in order to obtain the signal measurements for the one or more signals, the one or more processors are configured to cause the first UE to receive the signal measurements for the one or more signals from the second UE;
the signal measurements for the one or more signals received from the second UE are performed by the second UE for the second UE;
in order to generate the prediction data, the one or more processors are configured to cause the first UE to generate the prediction data for the second UE by inputting the signal measurements received from the second UE into the second prediction model for the second UE;
in order to obtain the signal measurements for the one or more signals, the one or more processors are further configured to cause the first UE to perform the signal measurements for the one or more signals for the second UE; and
in order to generate the prediction data for the second UE, the one or more processors are configured to cause the first UE to generate the prediction data for the second UE by inputting the signal measurements performed by the first UE for the second UE into the second prediction model for the second UE with the signal measurements for the one or more signals received from the second UE.

15. The first UE of claim 11, wherein:
the signal measurements comprise signal measurements for the first UE and signal measurements for at least the second UE;
in order to obtain the signal measurements for the one or more signals, the one or more processors are configured to cause the first UE to:
perform the signal measurements for the first UE; and
one of:
receive, from at least the second UE, the signal measurements for at least the second UE; or
perform the signal measurements for at least the second UE;
the one or more processors are further configured to cause the first UE to generate aggregated signal measurements by aggregating the signal measurements for the first UE with the signal measurements for at least the second UE;
in order to generate the prediction data by inputting the signal measurements into the one or more prediction models, the one or more processors are configured to cause the first UE to input the aggregated signal measurements into the first prediction model;
the prediction data generated by inputting the aggregated signal measurements into the first prediction model comprises intermediate prediction data; and
in order to transmit the report, the one or more processors are configured to cause the first UE to transmit the intermediate prediction data to at least the second UE to be further input into the second prediction model by at least the second UE.

16. The first UE of claim 11, wherein:
in order to obtain the signal measurements for the one or more signals, the one or more processors are configured to cause the first UE to perform the signal measurements for the one or more signals; and
the one or more processors are further configured to cause the first UE to:
transmit the signal measurements performed by the first UE to the second UE; and
receive intermediate prediction data from the second UE;
the intermediate prediction data includes prediction data generated by the second UE based on the second prediction model and aggregated signal measurements associated with at least the first UE and the second UE;
the aggregated signal measurements comprise:
the signal measurements performed by the first UE and transmitted to the second UE; and
signal measurements performed by the second UE;
the one or more processors are configured to cause the first UE to generate final prediction data by inputting the intermediate prediction data received from the second UE into the first prediction model; and
the final prediction data includes at least first prediction data for the first UE and second prediction data for the second UE.

17. The first UE of claim 1, wherein:
the prediction data is generated at a first period of time; and
the prediction data comprises a predicted signal measurement for a signal for a second period of time occurring after the first period of time; and
the one or more processors are further configured to cause the first UE to:
perform, during the second period of time, an actual signal measurement for the signal corresponding to the predicted signal measurement;
determine a performance metric associated with the prediction data; and
transmit, to a network entity, a performance report indicating the performance metric when one or more conditions are satisfied; and
the one or more conditions comprise the performance metric being greater than or equal to an error threshold.

18. The first UE of claim 17, wherein:
the one or more processors are further configured to cause the first UE to receive, from the network entity, one or more criteria for determining the performance metric; and
the one or more criteria comprise at least one of:
a measurement correlation criterion associated with the signal measurements associated with the group of UEs;
a geographical correlation criterion associated with UEs in the group of UEs; or
a channel quality or signal strength criterion associated with the signal measurements associated with the group of UEs.

19. A method for wireless communication by first user equipment (UE), comprising:
determining a group of UEs for cooperative-based operation in which at least one of signal measurements are cooperatively performed among the group of UEs or prediction data is cooperatively generated among the group of UEs;
obtaining, according to the cooperative-based operation, signal measurements for one or more signals;
generating, according to the cooperative-based operation, prediction data by inputting the signal measurements into one or more prediction models; and
transmitting a report indicating at least one of the signal measurements or the prediction data.

20. A non-transitory computer-readable medium for wireless communication by a first user equipment (UE), comprising:
instructions that, when executed by one or more processors of the first UE, cause the first UE to:
determine a group of UEs for cooperative-based operation in which at least one of signal measurements are cooperatively performed among the group of UEs or prediction data is cooperatively generated among the group of UEs;
obtain, according to the cooperative-based operation, signal measurements for one or more signals;
generate, according to the cooperative-based operation, prediction data by inputting the signal measurements into one or more prediction models; and
transmit a report indicating at least one of the signal measurements or the prediction data.
